(19) United States
(12) Patent Application Publication
(10) Pub. No.: US 2026/0214243 A1
(43) Pub. Date: Jul. 23, 2026

(54) ENHANCED INTRA BLOCK COPY

(71) Applicant: Nokia Technologies Oy, Espoo (FI)

(72) Inventors: Ramin GHAZNAVI YOUVALARI, Tampere (FI); Döne BUGDAYCI SANSLI, Tampere (FI); Pekka ASTOLA, Tampere (FI)

(21) Appl. No.: 19/143,793

(22) PCT Filed: Jan. 2, 2024
(86) PCT No.: PCT/IB2024/050028

§ 371 Date: Jun. 26, 2025

Related U.S. Application Data
(60) Provisional application No. 63/436,949, filed on Jan. 4, 2023.

(51) Int. Cl. H04N 19/159; H04N 19/105; H04N 19/117; H04N 19/176; H04N 19/593; H04N 19/80

(52) U.S. Cl. CPC H04N 19/159; H04N 19/105; H04N 19/117; H04N 19/176; H04N 19/593; H04N 19/80

(57) ABSTRACT

A method including copying a reference sample area of an image frame for an image intra prediction; applying at least one filter to at least partially change the copied reference sample area to form a modified version of the copied reference sample area; and using the modified version of the copied reference sample area for the image intra prediction to form another area of the same image frame.

### TECHNICAL FIELD

The example and non-limiting embodiments relate generally to video coding and decoding and, more particularly, to intra block copy.

### BACKGROUND

Block-based processing is widely used in video coding, as it provides a good tradeoff between coding efficiency and computational complexity. Intra block copy tools are known to be able to generate a prediction for a current block.

### SUMMARY

The following summary is merely intended to be an example. The summary is not intended to limit the scope of the claims.

In accordance with one example, a method is provided comprising: copying a reference sample area of an image frame for an image intra prediction; applying at least one filter to at least partially change the copied reference sample area to form a modified version of the copied reference sample area; and using the modified version of the copied reference sample area for the image intra prediction to form another area of the same image frame.

In accordance with another example, an apparatus is provided comprising: at least one processor; and at least one non-transitory memory storing instructions that, when executed with the at least one processor, cause the apparatus to perform: copying a reference sample area of an image frame for an image intra prediction; applying at least one filter to at least partially change the copied reference sample area to form a modified version of the copied reference sample area; and using the modified version of the copied reference sample area for the image intra prediction to form another area of the same image frame.

In accordance with another example, a non-transitory computer readable medium comprising program instructions is provided that, when executed with an apparatus, cause the apparatus to perform at least the following: copying a reference sample area of an image frame for an image intra prediction; applying at least one filter to at least partially change the copied reference sample area to form a modified version of the copied reference sample area; and using the modified version of the copied reference sample area for the image intra prediction to form another area of the same image frame.

In accordance with another example, a method is provided comprising: determining one or more filter parameters comprising at least one of: receiving, for an image frame, at least one of the one or more filter parameters from an encoder, or determining at least one of the one or more filter parameters using at least one reconstructed reference sample of the image frame; and at least one of: using the determined one or more filter parameters to select at least one filter from a plurality of different filters, or supplying the determined one or more filter parameters to at least one filter, where the at least one filter is configured to at least partially change information from a copied reference sample area, from the image frame, to form a modified version of the copied reference sample area for use in a current area to be coded.

In accordance with another example, an apparatus is provided comprising: at least one processor; and at least one non-transitory memory storing instructions that, when executed with the at least one processor, cause the apparatus to perform: determining one or more filter parameters comprising at least one of: receiving, for an image frame, at least one of the one or more filter parameters from an encoder, or determining at least one of the one or more filter parameters using at least one reconstructed reference sample of the image frame; and at least one of: using the determined one or more filter parameters to select at least one filter from a plurality of different filters, or supplying the determined one or more filter parameters to at least one filter, where the at least one filter is configured to at least partially change information from a copied reference sample area, from the image frame, to form a modified version of the copied reference sample area for use in a current area to be coded.

In accordance with another example, a non-transitory computer readable medium comprising program instructions is provided that, when executed with an apparatus, cause the apparatus to perform at least the following: determining one or more filter parameters comprising at least one of: receiving, for an image frame, at least one of the one or more filter parameters from an encoder, or determining at least one of the one or more filter parameters using at least one reconstructed reference sample of the image frame; and at least one of: using the determined one or more filter parameters to select at least one filter from a plurality of different filters, or supplying the determined one or more filter parameters to at least one filter, where the at least one filter is configured to at least partially change information from a copied reference sample area, from the image frame, to form a modified version of the copied reference sample area for use in a current area to be coded.

In accordance with another example, a method is provided comprising: determining one or more filter parameters comprising at least one of: determining with an encoder, for an image frame, at least one predefined filter parameter, or determining with the encoder, for the image frame, at least one non-predefined filter parameter, where the one or more filter parameters are configured for use with a decoder for a filtering process, where the filtering process comprises applying at least one filter to at least partially change a copied reference sample area, from the image frame, to form a modified version of the copied reference sample area; and transmitting the one or more filter parameters for use with the decoder.

In accordance with another example, an apparatus is provided comprising: at least one processor; and at least one non-transitory memory storing instructions that, when executed with the at least one processor, cause the apparatus to perform: determining one or more filter parameters comprising at least one of: determining with an encoder, for an image frame, at least one predefined filter parameter, or determining with the encoder, for the image frame, at least one non-predefined filter parameter, where the one or more filter parameters are configured for use with a decoder for a filtering process, where the filtering process comprises applying at least one filter to at least partially change a copied reference sample area, from the image frame, to form a modified version of the copied reference sample area; and transmitting the one or more filter parameters for use with the decoder.

In accordance with another example, a non-transitory computer readable medium comprising program instructions is provided that, when executed with an apparatus, cause the apparatus to perform at least the following: determining one or more filter parameters comprising at least one of: determining with an encoder, for an image frame, at least one predefined filter parameter, or determining with the encoder, for the image frame, at least one non-predefined filter parameter, where the one or more filter parameters are configured for use with a decoder for a filtering process, where the filtering process comprises applying at least one filter to at least partially change a copied reference sample area, from the image frame, to form a modified version of the copied reference sample area; and transmitting the one or more filter parameters for use with the decoder.

In accordance with another example, a method is provided comprising: copying a reference sample area of an image frame for a block copy-based image intra prediction where a block vector is either signaled by an encoder to a decoder or derived by both the encoder and the decoder through template matching; deriving of at least one filter using at least a portion of reconstructed samples in template regions defined in neighborhood of a current block and/or neighborhood of a reference block; applying the at least one of derived filters to at least partially modify the copied reference sample area to form a modified version of the copied reference sample area; and using the modified version of the copied reference sample area for an image intra prediction to form another area of the same image frame.

The method may further include, wherein deriving parameters of the at least one filter and/or applying the at least one filter comprises using information available at a time of coding the current block comprising at least one of: one or more of spatial reconstructed samples in a neighborhood of the current block; one or more of spatial reconstructed samples in a neighborhood of the reference block; one or more of spatial reconstructed samples in a neighborhood of a block other than the current block and other than the reference block; one or more of location information of the spatial reconstructed samples in the neighborhood of the reference block; one or more of location information of the spatial reconstructed samples in the neighborhood of the current block; one or more of gradient information of the spatial reconstructed samples in the neighborhood of the current block; one or more of gradient information of the spatial reconstructed samples in the neighborhood of the reference block; one or more of direct coding (DC) or average values of the spatial reconstructed samples in the neighborhood of the current block; one or more of direct coding (DC) or average values of the spatial reconstructed samples in the neighborhood of the reference block; or a bias or an offset value.

The method may further include, wherein the derivation of the at least one filter comprises determining filter coefficients based on minimization of an error.

The method may further include, wherein applying the at least one filter comprises: generating a list of reference candidates as reference blocks to be filtered; deriving filter parameters for each candidate reference block; applying the at least one filter on the template area of the reference block; calculating a template cost using a metric based on difference of samples in a template of the current block and a template of reference blocks; and selecting a block/filter pair based on the template cost.

The method may further include, wherein the template cost is calculated using one or more of sum of absolute differences (SAD), sum of square errors (SSE), any other difference measuring metrics, or a distance measuring metric.

The method may further include: determining to apply the at least one filter, wherein a decision for the applying the at least one filter for an intra block copy (IBC) block is at least partially decided using information from a co-located block in a reference channel.

The method may further include, wherein the at least one filter comprises two or more filters derived for different sample intensity ranges in a template area, and applied to corresponding samples in those ranges in the current block.

The method may further include determining at least one of a filter size or a filter type based on at least one of: block size; availability of reference samples in the neighborhood of the current block; or availability of reference samples in the neighborhood of the reference block.

In another example an apparatus is provided comprising: at least one processor; and at least one memory storing instructions that, when executed by the at least one processor, cause the apparatus at least to perform: copying a reference sample area of an image frame for a block copy-based image intra prediction where a block vector is either signaled by an encoder to a decoder or derived by both the encoder and the decoder through template matching; deriving of at least one filter using at least a portion of reconstructed samples in template regions defined in neighborhood of a current block and/or neighborhood of a reference block; applying the at least one of derived filters to at least partially modify the copied reference sample area to form a modified version of the copied reference sample area; and using the modified version of the copied reference sample area for an image intra prediction to form another area of the same image frame.

The apparatus may further include, wherein to perform deriving parameters of the at least one filter and/or applying the at least one filter, the apparatus is caused to perform: using information available at a time of coding the current block comprising at least one of: one or more of spatial reconstructed samples in a neighborhood of the current block; one or more of spatial reconstructed samples in a neighborhood of the reference block; one or more of spatial reconstructed samples in a neighborhood of a block other than the current block and other than the reference block; one or more of location information of the spatial reconstructed samples in the neighborhood of the reference block; one or more of location information of the spatial reconstructed samples in the neighborhood of the current block; one or more of gradient information of the spatial reconstructed samples in the neighborhood of the current block; one or more of gradient information of the spatial reconstructed samples in the neighborhood of the reference block; one or more of direct coding (DC) or average values of the spatial reconstructed samples in the neighborhood of the current block; one or more of direct coding (DC) or average values of the spatial reconstructed samples in the neighborhood of the reference block; or a bias or an offset value.

The apparatus may further include, wherein the derivation of the at least one filter comprises determining filter coefficients based on minimization of an error.

The apparatus may further include, wherein to perform applying the at least one filter, the apparatus is caused to perform: generating a list of reference candidates as reference blocks to be filtered; deriving filter parameters for each candidate reference block; applying the at least one filter on the template area of the reference block; calculating a template cost using a metric based on difference of samples in a template of the current block and a template of reference blocks; and selecting a block/filter pair based on the template cost.

The apparatus may further include, wherein the template cost is calculated using one or more of sum of absolute differences (SAD), sum of square errors (SSE), any other difference measuring metrics, or a distance measuring metric.

The apparatus may further include, wherein the apparatus is further caused to perform: determining to apply the at least one filter, wherein a decision for the applying the at least one filter for an intra block copy (IBC) block is at least partially decided using information from a co-located block in a reference channel.

The apparatus may further include, wherein the at least one filter comprises two or more filters derived for different sample intensity ranges in a template area, and applied to corresponding samples in those ranges in the current block.

The apparatus may further include, wherein the apparatus is further caused to perform: determining at least one of a filter size or a filter type based on at least one of: block size; availability of reference samples in the neighborhood of the current block; or availability of reference samples in the neighborhood of the reference block.

In another example, a computer readable medium is provided comprising program instructions that, when executed with an apparatus, cause the apparatus to perform at least the following: copying a reference sample area of an image frame for a block copy-based image intra prediction where a block vector is either signaled by an encoder to a decoder or derived by both the encoder and the decoder through template matching; deriving of at least one filter using at least a portion of reconstructed samples in template regions defined in neighborhood of a current block and/or neighborhood of a reference block; applying the at least one of derived filters to at least partially modify the copied reference sample area to form a modified version of the copied reference sample area; and using the modified version of the copied reference sample area for an image intra prediction to form another area of the same image frame.

The computer readable medium may further include, wherein to perform deriving parameters of the at least one filter and/or applying the at least one filter, the apparatus is caused to perform: using information available at a time of coding the current block comprising at least one of: one or more of spatial reconstructed samples in a neighborhood of the current block; one or more of spatial reconstructed samples in a neighborhood of the reference block; one or more of spatial reconstructed samples in a neighborhood of a block other than the current block and other than the reference block; one or more of location information of the spatial reconstructed samples in the neighborhood of the reference block; one or more of location information of the spatial reconstructed samples in the neighborhood of the current block; one or more of gradient information of the spatial reconstructed samples in the neighborhood of the current block; one or more of gradient information of the spatial reconstructed samples in the neighborhood of the reference block; one or more of direct coding (DC) or average values of the spatial reconstructed samples in the neighborhood of the current block; one or more of direct coding (DC) or average values of the spatial reconstructed samples in the neighborhood of the reference block; or a bias or an offset value.

The computer readable medium may further include, wherein the derivation of the at least one filter comprises determining filter coefficients based on minimization of an error.

The computer readable medium may further include, wherein to perform applying the at least one filter, the apparatus is caused to perform: generating a list of reference candidates as reference blocks to be filtered; deriving filter parameters for each candidate reference block; applying the at least one filter on the template area of the reference block; calculating a template cost using a metric based on difference of samples in a template of the current block and a template of reference blocks; and selecting a block/filter pair based on the template cost.

The computer readable medium may further include, wherein the template cost is calculated using one or more of sum of absolute differences (SAD), sum of square errors (SSE), any other difference measuring metrics, or a distance measuring metric.

The computer readable medium may further include, wherein the apparatus is further caused to perform: determining to apply the at least one filter, wherein a decision for the applying the at least one filter for an intra block copy (IBC) block is at least partially decided using information from a co-located block in a reference channel.

The computer readable medium may further include, wherein the at least one filter comprises two or more filters derived for different sample intensity ranges in a template area, and applied to corresponding samples in those ranges in the current block.

The computer readable medium may further include, wherein the apparatus is further caused to perform: determining at least one of a filter size or a filter type based on at least one of: block size; availability of reference samples in the neighborhood of the current block; or availability of reference samples in the neighborhood of the reference block.

The computer readable medium may further include, wherein the computer readable medium comprises a non-transitory computer readable medium.

In another example an apparatus is provided comprising: means for copying a reference sample area of an image frame for a block copy-based image intra prediction where a block vector is either signaled by an encoder to a decoder or derived by both the encoder and the decoder through template matching; means for deriving of at least one filter using at least a portion of reconstructed samples in template regions defined in neighborhood of a current block and/or neighborhood of a reference block; means for applying the at least one of derived filters to at least partially modify the copied reference sample area to form a modified version of the copied reference sample area; and means for using the modified version of the copied reference sample area for an image intra prediction to form another area of the same image frame.

According to some example, there is provided the subject matter of the independent claims. Some further examples are provided in subject matter of the dependent claims.

### BRIEF DESCRIPTION OF THE DRAWINGS

The foregoing examples and other features are explained in the following description, taken in connection with the accompanying drawings, wherein:

FIG. 1 is a block diagram of one possible and non-limiting exemplary system in which the exemplary embodiments may be practiced;

FIG. 2 illustrates a block diagram of an exemplary apparatus (a terminal device) used to implement one or more of the entities in FIG. 1;

FIGS. 3A and 3B are diagrams illustrating locations of samples used for derivations of α and β;

FIG. 4 is a diagram illustrating Classification of luma samples into two classes used in the derivation of two sets of a and J;

FIGS. 5A and 5B are illustrates of locations of the samples used for the derivation of CCCM filter when six reference lines are used, where FIG. 5A is for chroma and FIG. 5B is for luma;

FIG. 6 illustrates possible dimensions of a filter kernel, including a 3-tap vertical shape, a 3-tap horizontal shape, a 5-tap cross shape, and a 25-tap diamond shape;

FIG. 7 is a diagram illustrating an example of four reference lines neighboring to a prediction block;

FIG. 8 is a diagram illustrating an example of a matrix weighted intra prediction process;

FIG. 9 is a diagram illustrating an example of HoG computation from a template of width 3 pixels;

FIG. 10 is a diagram illustrating an example of a Low-Frequency Non-Separable Transform (LFNST) process;

FIG. 11 is a diagram illustrating an example of an intra template matching search area used;

FIG. 12 is a diagram illustrating an example of an IBC reference region depending on a current CU position;

FIG. 13 is a diagram illustrating an example of a reference area for IBC when CTU (m,n) is coded;

FIGS. 14A and 14B are diagrams illustrating BV adjustment for horizontal flip and vertical flip, respectively;

FIG. 15 is a diagram illustrating an example of a reference block and a current block together with associated templates and a block vector in IBC;

FIG. 16 is a diagram illustrating an example of samples over which the training is applied to provide multiple first predictions and a second prediction;

FIG. 17 is a diagram illustrating that a sample may be used from a co-located area of the other template;

FIG. 18 is a diagram illustrating that one or more of filter taps may point to outside of a template;

FIG. 19 is a diagram illustrating an example method;

FIG. 20 is a diagram illustrating an example method;

FIG. 21 is a diagram illustrating an example method; and

FIG. 22 is a diagram illustrating an example method.

### DETAILED DESCRIPTION

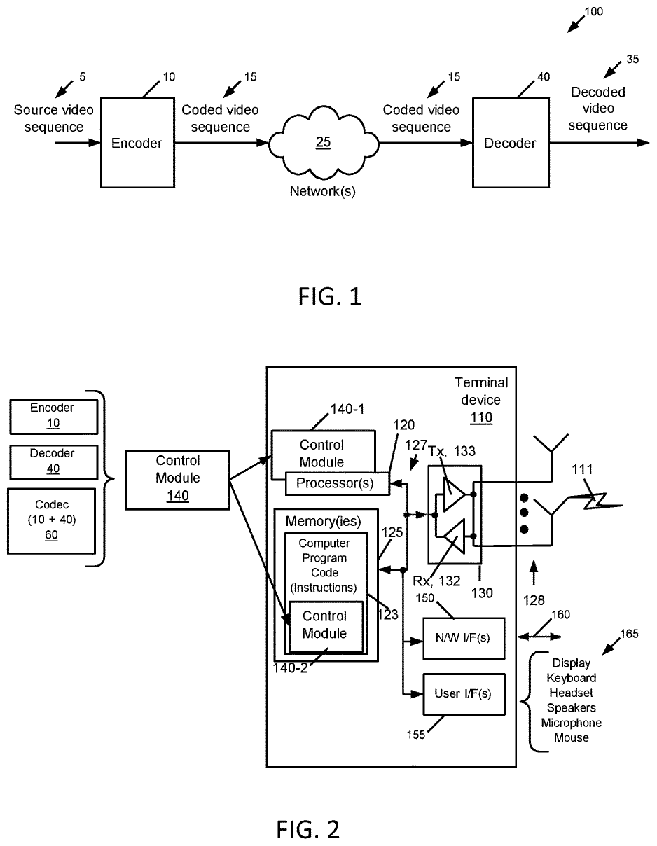

Turning to FIG. 1, this figure shows a block diagram of one possible and non-limiting example system 100 in which the example embodiments may be practiced. An encoder 10 analyzes a source video sequence 5 and produces a coded video sequence 15, which is communicated over a network 25 to a decoder 40. The decoder 40 analyzes the coded video sequence 15 and produces a reconstructed video sequence 35, which may be similar to the source video sequence 5.

The network 25 may be a singular network, such as a local area network for example. As other examples, the network 25 could include multiple networks, such as a local area network to get to the Internet, through the Internet to another local area network; a cellular network to another cellular network; or other combinations of networks.

The encoder 10 and decoder 40 may be implemented in many different apparatuses. Referring also to FIG. 2, this figure illustrates a block diagram of an exemplary apparatus (a terminal device 110 in this example) used to implement one or more of the entities in FIG. 1. The term “terminal device” is used since the example of FIG. 1 has a communication that terminates on both ends. The term terminal device is not meant to be limiting, and such a device can be any electronic device able to receive or transmit coded or uncoded video.

The terminal device 110 includes circuitry comprising one or more processors 120, one or more memories 125, one or more transceivers 130 (or receiver(s) and transmitter(s)), one or more network (N/W) interface(s) (I/Fs) 150, and one or more user I/F(s) 155 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128, which may communicate using wireless link 111 with other devices.

The one or more memories 125 include computer program code 123 (comprising instructions). The terminal device 110 includes a control module 140. The control module 140 may implement the encoder 10, the decoder 40, or a codec 60, which includes both an encoder 10 and a decoder 40.

The control module 140 comprises one of or both parts 140-1 and/or 140-2, which may be implemented in a number of ways. The control module 140 may be implemented in hardware as control module 140-1, such as being implemented as part of the one or more processors 120. The control module 140-1 may be implemented also as an integrated circuit or through other hardware such as a programmable gate array. In another example, the control module 140 may be implemented as control module 140-2, which is implemented as computer program code 123 and is executed by the one or more processors 120. For instance, the one or more memories 125 and (e.g., instructions in) the computer program code 123 may be configured to, in response to the one or more processors 120 executing the instructions, cause the user equipment 110 to perform one or more of the operations as described herein.

A wired network connection 160 may be used by the one or more network interfaces 150. The user interface(s) 155 may interface with user interface elements 165 such as, for example, a display, a keyboard, a headset (e.g., only earphones or earphones and microphone), speakers, a microphone, and/or mouse. Some of these can be internal, some can be internal, or there could be a combination of internal and external elements 165. For example, a smartphone as the terminal device 110 could have an internal display and internal speakers as elements 165, or a personal computer as the terminal device 110 could have a display, keyboard, mouse, and speakers that are external to the personal computer.

Having thus introduced one suitable but non-limiting technical context for the practice of the exemplary embodiments, the example embodiments will now be described with greater specificity.

Hybrid video codecs, for example ITU-T H.263, H.264/AVC and HEVC, may encode the video information in two phases. At first, pixel values in a certain picture are (or “block”) are predicted for example by motion compensation means (finding and indicating an area in one of the previously coded video frames that corresponds closely to the block being coded) or by spatial means (using the pixel values around the block to be coded in a specified manner). In the first phase, predictive coding may be applied, for example, as so-called sample prediction and/or so-called syntax prediction.

In the sample prediction, pixel or sample values in a certain picture area or “block” are predicted. These pixel or sample values can be predicted, for example, using one or more of motion compensation or intra prediction mechanisms.

Motion compensation mechanisms (which may also be referred to as inter prediction, temporal prediction or motion-compensated temporal prediction or motion-compensated prediction or MCP) involve finding and indicating an area in one of the previously encoded video frames that corresponds closely to the block being coded. Inter prediction may reduce temporal redundancy.

Intra prediction, where pixel or sample values can be predicted by spatial mechanisms, involve finding and indicating a spatial region relationship. Intra prediction utilizes the fact that adjacent pixels within the same picture are likely to be correlated. Intra prediction can be performed in spatial or transform domain, i.e., either sample values or transform coefficients can be predicted. Intra prediction is typically exploited in intra coding, where no inter prediction is applied.

In the syntax prediction, which may also be referred to as parameter prediction, syntax elements and/or syntax element values and/or variables derived from syntax elements are predicted from syntax elements (de)coded earlier and/or variables derived earlier. Non-limiting examples of syntax prediction are provided below.

In motion vector prediction, motion vectors e.g. for inter and/or inter-view prediction may be coded differentially with respect to a block-specific predicted motion vector. In many video codecs, the predicted motion vectors are created in a predefined way, for example by calculating the median of the encoded or decoded motion vectors of the adjacent blocks. Another way to create motion vector predictions, sometimes referred to as advanced motion vector prediction (AMVP), is to generate a list of candidate predictions from adjacent blocks and/or co-located blocks in temporal reference pictures and signaling the chosen candidate as the motion vector predictor. In addition to predicting the motion vector values, the reference index of previously coded/decoded picture can be predicted. The reference index is typically predicted from adjacent blocks and/or co-located blocks in temporal reference picture. Differential coding of motion vectors is typically disabled across slice boundaries.

The block partitioning, e.g. from CTU to CUs and down to PUs, may be predicted.

In filter parameter prediction, the filtering parameters e.g. for sample adaptive offset may be predicted.

Prediction approaches using image information from a previously coded image can also be called as inter prediction methods which may also be referred to as temporal prediction and motion compensation.

Prediction approaches using image information within the same image can also be called as intra prediction methods.

Secondly, the prediction error, i.e. the difference between the predicted block of pixels and the original block of pixels, is coded. This may be done by transforming the difference in pixel values using a specified transform (e.g. Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size of transmission bitrate).

In many video codecs, including H.264/AVC and HEVC, motion information is indicated by motion vectors associated with each motion compensated image block. Each of these motion vectors represents the displacement of the image block in the picture to be coded (in the encoder) or decoded (at the decoder) and the prediction source block in one of the previously coded or decoded images (or pictures). H.264/AVC and HEVC, as many other video compression standards, a picture is divided into a mesh of rectangles, for each of which a similar block in one of the reference pictures is indicated for inter prediction. The location of the prediction block is coded as a motion vector that indicates the position of the prediction block relative to the block being coded.

In under developing Versatile Video Codec (VVC), there are the following new coding tools:
Intra prediction
   67 intra mode with wide angles mode extension
   Block size and mode dependent 4 tap interpolation filter
   Position dependent intra prediction combination (PDPC)
   Cross component linear model intra prediction (CCLM)
   Multi-reference line intra prediction
   Intra sub-partitions
   Weighted intra prediction with matrix multiplication
Inter-picture prediction
   Block motion copy with spatial, temporal, history-based, and pairwise average merging candidates
   Affine motion inter prediction
   sub-block based temporal motion vector prediction
   Adaptive motion vector resolution
   8×8 block-based motion compression for temporal motion prediction
   High precision (1/16 pel) motion vector storage and motion compensation with 8-tap interpolation filter for luma component and 4-tap interpolation filter for chroma component
   Triangular partitions
   Combined intra and inter prediction
Merge with MVD (MMVD)
   Symmetrical MVD coding
   Bi-directional optical flow
   Decoder side motion vector refinement
   Bi-prediction with CU-level weight
Transform, quantization and coefficients coding
   Multiple primary transform selection with DCT2, DST7 and DCT8
   Secondary transform for low frequency zone
   Sub-block transform for inter predicted residual
   Dependent quantization with max QP increased from 51 to 63
   Transform coefficient coding with sign data hiding
   Transform skip residual coding
Entropy Coding
   Arithmetic coding engine with adaptive double windows probability update
In loop filter
   In-loop reshaping
   Deblocking filter with strong longer filter
   Sample adaptive offset
   Adaptive Loop Filter
Screen content coding:
   Current picture referencing with reference region restriction
360-degree video coding
   Horizontal wrap-around motion compensation
High-level syntax and parallel processing
   Reference picture management with direct reference picture list signalling
   Tile groups with rectangular shape tile groups

### Partitioning in VVC

In VVC, each picture is divided into coding tree units (CTUs) similar to HEVC. A picture may also be divided into slices, tiles, bricks and sub-pictures. CTU may be split into smaller CUs using quaternary tree structure. Each CU may be divided using quad-tree and nested multi-type tree including ternary and binary split.

There are specific rules to infer partitioning in in picture boundaries.

The redundant split patterns are disallowed in nested multi-type partitioning.

### Cross-Component Linear Model Prediction (CCLM)

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β \qquad ( 3 - 1 )$$

where pred_{C}(i,j) represents the predicted chroma samples in a CU and rec_{L}′(i,j) represents the downsampled reconstructed luma samples of the same CU.

The CCLM parameters (α and β) are derived with at most four neighbouring chroma samples and their corresponding down-sampled luma samples. Suppose the current chroma block dimensions are W×H, then W′ and H′ are set as:
W′=W, H′=H when LM mode is applied;
W′=W+H when LM-A mode is applied;
H′=H+W when LM-L mode is applied;
   The above neighbouring positions are denoted as S[0, −1] . . . S[W′−1, −1] and the left neighbouring positions are denoted as S[−1, 0] . . . S[−1, H′−1]. Then the four samples are selected as
S[W′/4,−1],S[3*W′/4,−1],S[−1,H′/4],S[−1,3*H′/4] when LM mode is applied and both above and left neighbouring samples are available;
S[W′/8,−1],S[3*W′/8,−1],S[5*W′/8,−1],S[7*W′/8,−1] when LM-A mode is applied or only the above neighbouring samples are available;
S[−1,H′/8],S[−1,3*H′/8],S[−1,5*H′/8],S[−1,7*H′/8] when LM-L mode is applied or only the left neighbouring samples are available;
The four neighboring luma samples at the selected positions are down-sampled and compared four times to find two smaller values: x0A and x1A, and two larger values: x0B and x1B. Their corresponding chroma sample values are denoted as y0A, y1A, y0B and y1B. Then xA, xB, yA and yB are derived as:

$${X}_{a} = ( {X}_{A}^{0} + {x}_{A}^{1} + 1 ) >> 1 ; {X}_{b} = ( {x}_{B}^{0} + {x}_{B}^{1} + 1 ) >> 1 ; \qquad ( 3 - 2 )$$

$${Y}_{a} = ( {y}_{A}^{0} + {y}_{A}^{1} + 1 ) >> 1 ; {Y}_{b} = ( {y}_{B}^{0} + {y}_{B}^{1} + 1 ) >> 1$$

Finally, the linear model parameters α and β are obtained according to the following equations.

$$α = \frac{{Y}_{a} - {Y}_{b}}{{X}_{a} - {X}_{b}} \qquad ( 3 - 3 )$$

$$β = {Y}_{b} - α \cdot {X}_{b}$$

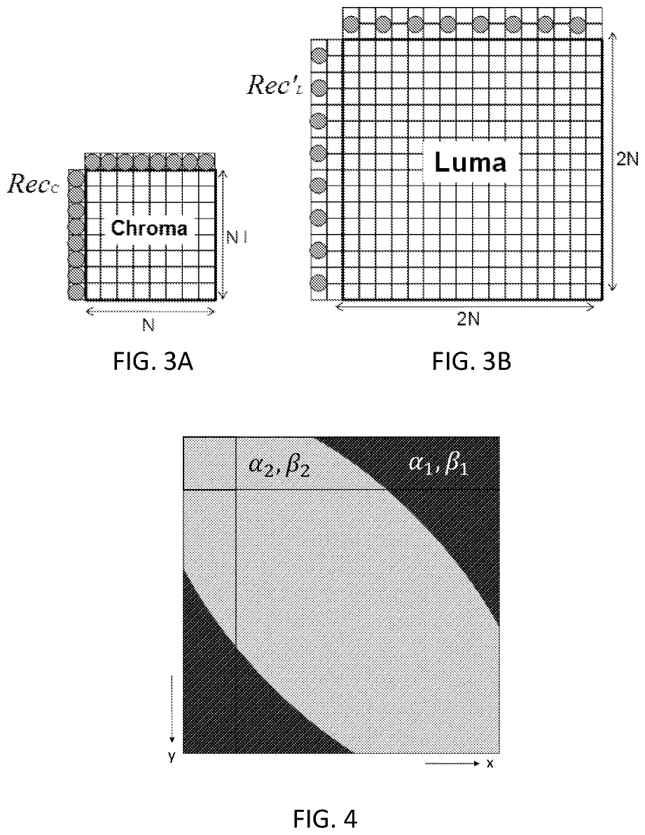

FIGS. 3A and 3B shows an example of the locations of the left and above samples and the sample of the current block involved in the CCLM mode; locations of the samples used for the derivation of α and β.
The division operation to calculate parameter α is implemented with a look-up table. To reduce the memory required for storing the table, the diff value (difference between maximum and minimum values)
and the parameter α are expressed by an exponential notation. For example, diff is approximated with a 4-bit significant part and an exponent. Consequently, the table for 1/diff is reduced into 16 elements for 16 values of the significand as follows:

$$DivTable [ ] = \{ 0 , 7 , 6 , 5 , 5 , 4 , 4 , 3 , 3 , 2 , 2 , 1 , 1 , 1 , 1 , 0 \} \qquad ( 3 - 4 )$$

This would have a benefit of both reducing the complexity of the calculation as well as the memory size required for storing the needed tables.

Besides the above template and left template can be used to calculate the linear model coefficients together, they also can be used alternatively in the other 2 LM modes, called LM_A, and LM_L modes.

In LM_A mode, only the above template is used to calculate the linear model coefficients. To get more samples, the above template is extended to (W+H). In LM_L mode, only left template is used to calculate the linear model coefficients. To get more samples, the left template is extended to (H+W).

For a non-square block, the above template is extended to W+W, the left template is extended to H+H.

To match the chroma sample locations for 4:2:0 video sequences, two types of downsampling filter are applied to luma samples to achieve 2 to 1 downsampling ratio in both horizontal and vertical directions. The selection of downsampling filter is specified by a SPS level flag. The two downsampling filters are as follows, which are corresponding to “type-0” and “type-2” content, respectively.

$${Rec}_{L}^{′} ( i , j ) = [ \begin{matrix}\begin{matrix}{rec}_{L} ( 2 i - 1 , 2 j - 1 ) + 2 \cdot {rec}_{L} ( 2 i - 1 , 2 j - 1 ) + \\ {rec}_{L} ( 2 i + 1 , 2 j - 1 ) + {rec}_{L} ( 2 i - 1 , 2 j ) + 2 \cdot {rec}_{L} ( 2 i , 2 j ) +\end{matrix} \\ {rec}_{L} ( 2 i + 1 , 2 j ) + 4\end{matrix} ] ≫ 3 \qquad ( 3 - 5 )$$

$${rec}_{L}^{′} ( i , j ) = [ \begin{matrix}{rec}_{L} ( 2 i , 2 j - 1 ) + {rec}_{L} ( 2 i - 1 , 2 j ) + 4 \cdot {rec}_{L} ( 2 i , 2 j ) + \\ {rec}_{L} ( 2 i + 1 , 2 j ) + {rec}_{L} ( 2 i , 2 j + 1 ) + 4\end{matrix} ] ≫ 3 \qquad ( 3 - 6 )$$

Note that only one luma line (general line buffer in intra prediction) is used to make the down-sampled luma samples when the upper reference line is at the CTU boundary.

This parameter computation is performed as part of the decoding process and is not just as an encoder search operation. As a result, no syntax is used to convey the α and β values to the decoder.

For chroma intra mode coding, a total of 8 intra modes are allowed for chroma intra mode coding. Those modes include five traditional intra modes and three cross-component linear model modes (CCLM, LM_A, and LM_L). Chroma mode signaling and derivation process are shown in Table 1. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the center position of the current chroma block is directly inherited.

TABLE 1
Derivation of chroma prediction mode
from luma mode when cclm_is enabled

| | Corresponding luma intra prediction mode | | | | |
|---|---|---|---|---|---|
| Chroma prediction | | | | | X |
| mode | 0 | 50 | 18 | 1 | (0 <= X <= 66) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |
| 5 | 81 | 81 | 81 | 81 | 81 |
| 6 | 82 | 82 | 82 | 82 | 82 |
| 7 | 83 | 83 | 83 | 83 | 83 |

A single binarization table is used regardless of the value of sps_cclm_enabled_flag as shown in Table 2.

TABLE 2
Unified binarization table for chroma prediction mode

| Value of | Bin |
|---|---|
| intra_chroma_pred_mode | string |
| 4 | 00 |
| 0 | 0100 |
| 1 | 0101 |
| 2 | 0110 |
| 3 | 0111 |
| 5 | 10 |
| 6 | 110 |
| 7 | 111 |

In Table 2, the first bin indicates whether it is regular (0) or LM modes (1). If it is LM mode, then the next bin indicates whether it is LM_CHROMA (0) or not. If it is not LM_CHROMA, next 1 bin indicates whether it is LM_L (0) or LM_A (1). For this case, when sps_cclm_enabled_flag is 0, the first bin of the binarization table for the corresponding intra_chroma_pred_mode can be discarded prior to the entropy coding. Or, in other words, the first bin is inferred to be 0 and hence not coded. This single binarization table is used for both sps_cclm_enabled_flag equal to 0 and 1 cases. The first two bins in Table are context coded with its own context model, and the rest bins are bypass coded.

In addition, in order to reduce luma-chroma latency in dual tree, when the 64×64 luma coding tree node is partitioned with Not Split (and ISP is not used for the 64×64 CU) or QT, the chroma CUs in 32×32/32×16 chroma coding tree node are allowed to use CCLM in the following way:
If the 32×32 chroma node is not split or partitioned QT split, all chroma CUs in the 32×32 node can use CCLM
If the 32×32 chroma node is partitioned with Horizontal BT, and the 32×16 child node does not split or uses Vertical BT split, all chroma CUs in the 32×16 chroma node can use CCLM.

In all the other luma and chroma coding tree split conditions, CCLM is not allowed for chroma CU.

### Multi-Model LM (MMLM)

The CCLM included in VVC is extended by adding three Multi-model LM (MMLM) modes. In each MMLM mode, the reconstructed neighboring samples are classified into two classes using a threshold which is the average of the luma reconstructed neighboring samples. The linear model of each class is derived using the Least-Mean-Square (LMS) method. For the CCLM mode, the LMS method is also used to derive the linear model. FIG. 4 illustrates two luma-to-chroma models obtained for luma (Y) threshold of 17; Classification of luma samples into two classes used in the derivation of two sets of α and β: top is the sample domain, and bottom is the spatial domain. Each luma-to-chroma model has its own linear model parameters α and β. As can be seen from the bottom, each luma-to-chroma model corresponds to a spatial segmentation of the content (i.e., they correspond to different objects or textures in the scene).

### Convolutional Cross-Component Model (CCCM)

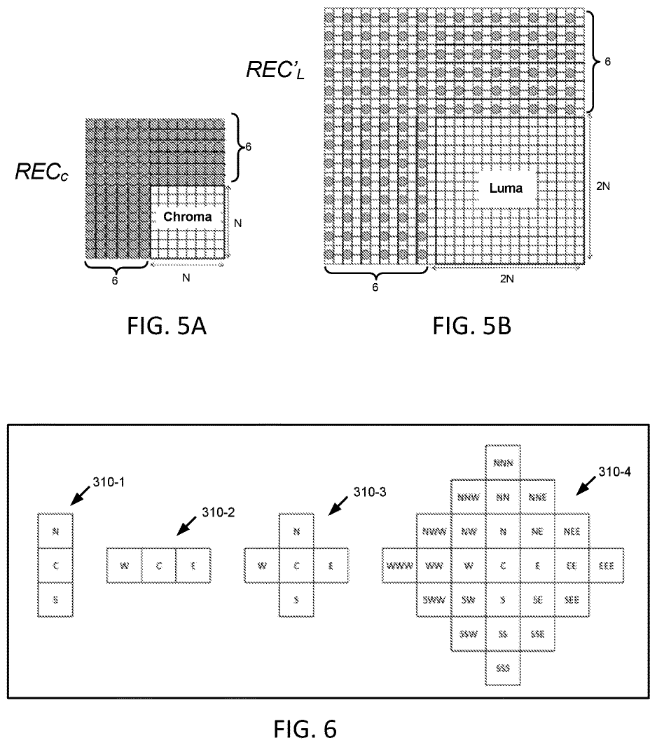

An improved version of cross-component prediction, known as CCCM, uses 2D filter kernel to derive the luma-to-chroma model. The CCCM filter coefficients are derived decoder-side using reconstructed set of input data and chroma samples. For the filter coefficient derivation, co-located reference sample areas (consisting of reconstructed luma and chroma samples) are defined for both luma (Rec′_{L}) and chroma (Rec_{c}) as shown in FIGS. 5A and 5B where the typically used 4:2:0 chroma down-sampling has been applied. The reference sample area for a given block can be, for example, six lines above and left as shown in FIGS. 5A and 5B, yet any number of reference lines (that can be realized by both the encoder and decoder) can be used. Generally, reference samples can contain any chroma and luma samples that have been reconstructed by both the encoder and decoder. Once the reference samples are determined the filter coefficients can be derived, for example, using different types of linear regression tools such as ordinary least-squares estimation, orthogonal matching pursuit, optimized orthogonal matching pursuit, ridge regression, or least absolute shrinkage and selection operator. Thus, these figures illustrate example locations of the samples used for the derivation of CCCM filter when six reference lines are used. Chroma is defined for an N×N block and luma is defined for a 2N×2N block. The reference sample area for a given block can be, for example, six lines above and left as shown in FIGS. 5A and 5B, yet any number of reference lines (that can be realized by both the encoder and decoder) can be used. Generally, reference samples can contain any chroma and luma samples that have been reconstructed by both the encoder and decoder. Once the reference samples are determined, the filter coefficients can be derived, for example, using different types of linear regression tools such as ordinary least-squares estimation, orthogonal matching pursuit, optimized orthogonal matching pursuit, ridge regression, or least absolute shrinkage and selection operator.

The dimensions of the filter kernel can be for example 1×3 (1D vertical), 3×1 (1D horizontal), 3×3, 7×7 or any dimensions, and can be shaped (by selecting only a subset of all possible kernel locations) as a cross or a diamond (as shown in FIG. 6) or as any given shape. The examples shown include: 3-tap vertical 310-1, 3-tap horizontal 310-2, 5-tap cross 310-3, and 25-tap diamond 310-4. When referring to the samples within the filter kernel the following notation is used: north (above), east (right), south (below), west (left) and center, as illustrated in FIG. 6 using the letters N, E, S, W, C.

The overall method of reconstructing chroma samples using convolution between a decoder-side obtained filter kernel and a set of input data is referred to as convolutional cross-component model (CCCM) here. The following steps can be applied to perform a CCCM operation:
1. Define co-located reference areas over the luma and chroma components.
2. Down-sample the luma samples to match the chroma grid (optional).
3. Scan the luma and chroma samples of the reference area and collect available statistics (such as auto-correlation matrix and cross-correlation vector) based on the filter shape.
4. Solve the filter coefficients by minimizing squared-error (or any other metric) based on the available statistics (such as the auto-correlation matrix and cross-correlation vector).
5. Calculate a predicted chroma block by convolving the down-sampled luma samples with the filter kernel.

One may define the (possibly down-sampled) luma samples as a 2D array Y(x, y) indexed using horizontal x-coordinate and vertical y-coordinate. One may also define the co-located chroma samples as a 2D array C(x, y) and the filter kernel (i.e., coefficients) as 3×3 array F(i, j). On a sample level we define the convolution between Y and F as,

$$C ( x , y ) = {\sum }_{j = - 1}^{j = 1} {\sum }_{i = - 1}^{i = 1} Y ( x + i , y + j ) \cdot F ( i + 1 , j + 1 ) .$$

When using other data terms, such as the non-linear square-root term, the appended convolution becomes,

$$C ( x , y ) = ( {\sum }_{j = - 1}^{j = 1} {\sum }_{i = - 1}^{i = 1} Y ( x + i , y + j ) \cdot F ( i + 1 , j + 1 ) ) + \hat{F} ( 0 ) \cdot \sqrt{Y ( x , y )} ,$$

where \hat{F} are filter coefficients that reside outside of the 2D filter kernel yet have been obtained as a part of the system of linear equations that were used to solve the 2D filter coefficients in Step 4 above. Similarly, we can add the bias term to the convolution with,

$$C ( x , y ) = ( {\sum }_{j = - 1}^{j = 1} {\sum }_{i = - 1}^{i = 1} Y ( x + i , y + j ) \cdot F ( i + 1 , j + 1 ) ) + \hat{F} ( 0 ) + \hat{F} ( 1 ) \cdot \sqrt{Y ( x , y )} ,$$

### Multiple Reference Line (MRL) Intra Prediction

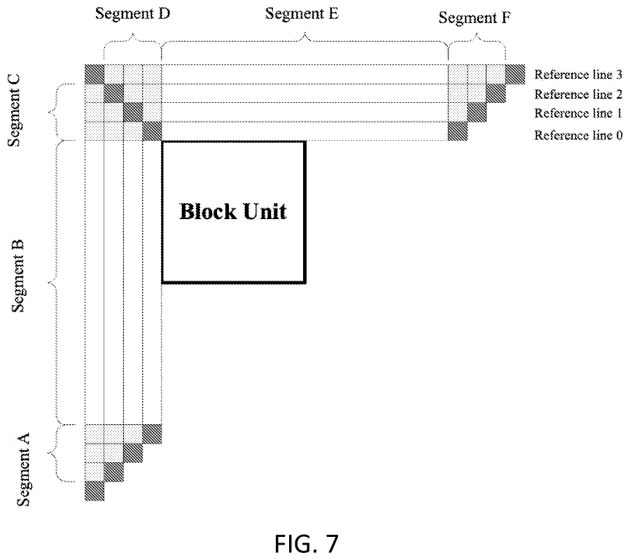

Multiple reference line (MRL) intra prediction uses more reference lines for intra prediction. In FIG. 7, an example of 4 reference lines is depicted (four reference lines neighboring to a prediction block) where the samples of segments A and F are not fetched from reconstructed neighboring samples, but padded with the closest samples from Segment B and E, respectively. HEVC intra-picture prediction uses the nearest reference line (i.e., reference line 0). In MRL, 2 additional lines (reference line 1 and reference line 3) are used.

The index of selected reference line (mrl_idx) is signaled and used to generate intra predictor. For reference line idx, which is greater than 0, only include additional reference line modes in MPM list and only signal mpm index without remaining mode. The reference line index is signaled before intra prediction modes, and Planar mode is excluded from intra prediction modes in case a nonzero reference line index is signaled.

MRL is disabled for the first line of blocks inside a CTU to prevent using extended reference samples outside the current CTU line. Also, PDPC is disabled when additional line is used. For MRL mode, the derivation of DC value in DC intra prediction mode for non-zero reference line indices are aligned with that of reference line index 0. MRL requires the storage of 3 neighboring luma reference lines with a CTU to generate predictions. The Cross-Component Linear Model (CCLM) tool also requires 3 neighboring luma reference lines for its down-sampling filters. The definition of MLR to use the same 3 lines is aligned as CCLM to reduce the storage requirements for decoders.

### Intra Sub-Partitions (ISP)

The intra sub-partitions (ISP) divides luma intra-predicted blocks vertically or horizontally into 2 or 4 sub-partitions depending on the block size. For example, minimum block size for ISP is 4×8 (or 8×4). If block size is greater than 4×8 (or 8×4) then the corresponding block is divided by 4 sub-partitions. It has been noted that the M×128 (with M≤64) and 128×N (with N≤64) ISP blocks could generate a potential issue with the 64×64 VDPU. For example, an M×128 CU in the single tree case has an M×128 luma TB and two corresponding

$$\frac{M}{2} \times 64$$

chroma TBs. If the CU uses ISP, then the luma TB will be divided into four M×32 TBs (only the horizontal split is possible), each of them smaller than a 64×64 block. However, in the current design of ISP chroma blocks are not divided. Therefore, both chroma components will have a size greater than a 32×32 block. Analogously, a similar situation could be created with a 128×N CU using ISP. Hence, these two cases are an issue for the 64×64 decoder.

### Matrix Weighted Intra Prediction (MIP)

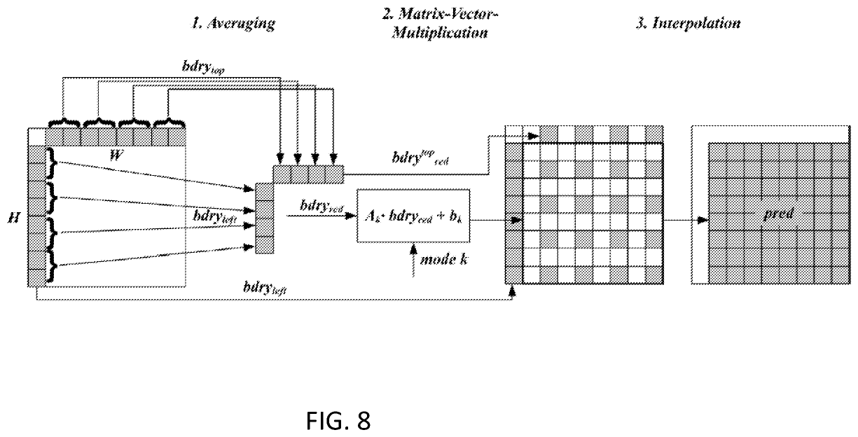

Matrix weighted intra prediction (MIP) method is a newly added intra prediction technique into VVC. For predicting the samples of a rectangular block of width W and height H, matrix weighted intra prediction (MIP) takes one line of H reconstructed neighboring boundary samples left of the block and one line of W reconstructed neighbouring boundary samples above the block as input. If the reconstructed samples are unavailable, they are generated as it is done in the conventional intra prediction. The generation of the prediction signal is based on the following three steps, which are averaging, matrix vector multiplication and linear interpolation as shown in FIG. 8; a Matrix weighted intra prediction process.

### Decoder Side Intra Mode Derivation (DIMD)

When DIMD is applied, two intra modes are derived from the reconstructed neighbor samples, and those two predictors are combined with the planar mode predictor with the weights derived from the gradients as described in JVET-00449. The division operations in weight derivation is performed utilizing the same lookup table (LUT) based integerization scheme used by the CCLM. For example the division operation in the orientation calculation

$$Orient = {G}_{y} / {G}_{χ}$$

computed by the following LUT-based scheme:

$$x = Floor ( Log 2 ( G x ) )$$

$$normDiff = ( ( Gx << 4 ) >> x ) \& 15$$

$$x += ( 3 + ( normDiff != 0 ) ? 1 : 0 )$$

$$Orient = ( Gy * ( DivSigTable [ normDiff ] \vert 8 ) + ( 1 << ( x - 1 ) ) ) >> x$$

$$where$$

$$DivS i g T a b l e [ 16 ] = \{ 0 , 7 , 6 , 5 , 5 , 4 , 4 , 3 , 3 , 2 , 2 , 1 , 1 , 1 , 1 , 0 \} .$$

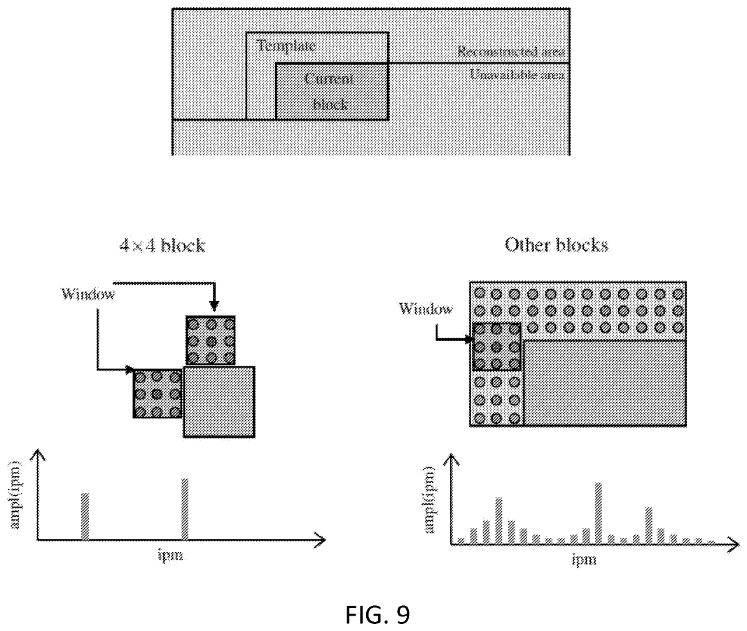

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks. FIG. 9 illustrates an example of HoG computation from a template of width 3 pixels.

### Fusion for Template-Based Intra Mode Derivation (TIMD)

For each intra prediction mode in MPMs, The SATD between the prediction and reconstruction samples of the template is calculated. First two intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes.

The costs of the two selected modes are compared with a threshold, in the test the cost factor of 2 is applied as follows:

$$costMode 2 < 2 * costMode 1.$$

If this condition is true, the fusion is applied, otherwise the only model is used.

Weights of the modes are computed from their SATD costs as follows:

$$weight 1 = costMode 2 / ( costMode 1 + costMode 2 )$$

$$weight 2 = 1 - weight 1$$

The division operations are conducted using the same lookup table (LUT) based integerization scheme used by the CCLM.

### Low-Frequency Non-Separable Transform (LFNST)

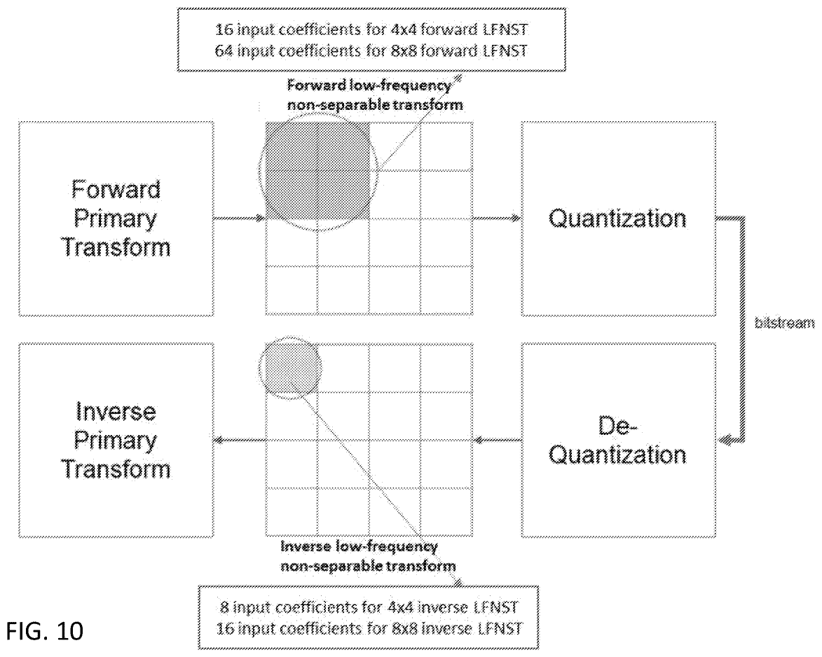

In VVC, LFNST is applied between forward primary transform and quantization (at encoder) and between de-quantization and inverse primary transform (at decoder side) as shown in FIG. 10; an example Low-Frequency Non-Separable Transform (LFNST) process. In LFNST, 4×4 non-separable transform or 8×8 non-separable transform is applied according to block size. For example, 4×4 LFNST is applied for small blocks (i.e., min (width, height)<8) and 8×8 LFNST is applied for larger blocks (i.e., min (width, height)>4).

Application of a non-separable transform, which is being used in LFNST, is described as follows using input as an example. To apply 4×4 LFNST, the 4×4 input block X

$$X = [ \begin{matrix}{X}_{00} & {X}_{01} & {X}_{02} & {X}_{03} \\ {X}_{10} & {X}_{11} & {X}_{12} & {X}_{13} \\ {X}_{20} & {X}_{21} & {X}_{22} & {X}_{23} \\ {X}_{30} & {X}_{31} & {X}_{32} & {X}_{33}\end{matrix} ] \qquad ( 3 - 7 )$$

is first represented vector [symbol] :

$$\vec{X} = {[ \begin{matrix}{X}_{00} & {X}_{01} & {X}_{02} & {X}_{03} & {X}_{10} & {X}_{11} & {X}_{12} & {X}_{13} & {X}_{20} & {X}_{21} & {X}_{22} & {X}_{23} & {X}_{30} & {X}_{31} & {X}_{32} & {X}_{33}\end{matrix} ]}^{T} \qquad ( 3 - 8 )$$

The non-separable transform is calculated as [symbol] =T· [symbol] , where [symbol] indicates the transform coefficient vector, and T is a 16×16 transform matrix. The 16×1 coefficient vector [symbol] is subsequently re-organized as 4×4 block using the scanning order for that block (horizontal, vertical or diagonal). The coefficients with smaller index will be placed with the smaller scanning index in the 4×4 coefficient block.

### Reduced Non-Separable Transform

LFNST (low-frequency non-separable transform) is based on direct matrix multiplication approach to apply non-separable transform so that it is implemented in a single pass without multiple iterations. However, the non-separable transform matrix dimension needs to be reduced to minimize computational complexity and memory space to store the transform coefficients. Hence, reduced non-separable transform (or RST) method is used in LFNST. The main idea of the reduced non-separable transform is to map an N (N is commonly equal to 64 for 8×8 NSST) dimensional vector to an R dimensional vector in a different space, where N/R (R<N) is the reduction factor. Hence, instead of N×N matrix, RST matrix becomes an R×N matrix as follows:

$${T}_{RxN} = [ \begin{matrix}{t}_{11} & {t}_{12} & {t}_{13} & … & {t}_{1 N} \\ {t}_{21} & {t}_{22} & {t}_{23} & & {t}_{2 N} \\ & ⋮ & & ⋱ & ⋮ \\ {t}_{R 1} & {t}_{R 2} & {t}_{R 3} & … & {t}_{RN}\end{matrix} ] \qquad ( 3 - 9 )$$

where the R rows of the transform are R bases of the N dimensional space. The inverse transform matrix for RT is the transpose of its forward transform. For 8×8 LFNST, a reduction factor of 4 is applied, and 64×64 direct matrix, which is conventional 8×8 non-separable transform matrix size, is reduced to 16×48 direct matrix. Hence, the 48×16 inverse RST matrix is used at the decoder side to generate core (primary) transform coefficients in 8×8 top-left regions. When 16×48 matrices are applied instead of 16×64 with the same transform set configuration, each of which takes 48 input data from three 4×4 blocks in a top-left 8×8 block excluding right-bottom 4×4 block. With the help of the reduced dimension, memory usage for storing all LFNST matrices is reduced from 10 KB to 8 KB with reasonable performance drop. In order to reduce complexity LFNST is restricted to be applicable only if all coefficients outside the first coefficient sub-group are non-significant. Hence, all primary-only transform coefficients have to be zero when LFNST is applied. This allows a conditioning of the LFNST index signaling on the last-significant position, and hence avoids the extra coefficient scanning in the current LFNST design, which is needed for checking for significant coefficients at specific positions only. The worst-case handling of LFNST (in terms of multiplications per pixel) restricts the non-separable transforms for 4×4 and 8×8 blocks to 8×16 and 8×48 transforms, respectively. In those cases, the last-significant scan position has to be less than 8 when LFNST is applied, for other sizes less than 16. For blocks with a shape of 4×N and N×4 and N>8, the proposed restriction implies that the LFNST is now applied only once, and that to the top-left 4×4 region only. As all primary-only coefficients are zero when LFNST is applied, the number of operations needed for the primary transforms is reduced in such cases. From encoder perspective, the quantization of coefficients is remarkably simplified when LFNST transforms are tested. A rate-distortion optimized quantization has to be done at maximum for the first 16 coefficients (in scan order), the remaining coefficients are enforced to be zero.

### LFNST Transform Selection

There are totally 4 transform sets and 2 non-separable transform matrices (kernels) per transform set are used in LFNST. The mapping from the intra prediction mode to the transform set is pre-defined as shown in Table 0-1. If one of three CCLM modes (INTRA_LT_CCLM, INTRA_T_CCLM or INTRA_L_CCLM) is used for the current block (81<=predModeIntra<=83), transform set 0 is selected for the current chroma block. For each transform set, the selected non-separable secondary transform candidate is further specified by the explicitly signaled LFNST index. The index is signaled in a bit-stream once per Intra CU after transform coefficients.

TABLE 0-1
Transform selection table

| | Tr. set |
|---|---|
| IntraPredMode | index |
| IntraPredMode < 0 | 1 |
| 0 <= IntraPredMode <= 1 | 0 |
| 2 <= IntraPredMode <= 12 | 1 |
| 13 <= IntraPredMode <= 23 | 2 |
| 24 <= IntraPredMode <= 44 | 3 |
| 45 <= IntraPredMode <= 55 | 2 |
| 56 <= IntraPredMode <= 80 | 1 |
| 81 <= IntraPredMode <= 83 | 0 |

LFNST Index Signaling and Interaction with Other Tools

Since LFNST is restricted to be applicable only if all coefficients outside the first coefficient sub-group are non-significant, LFNST index coding depends on the position of the last significant coefficient. In addition, the LFNST index is context coded but does not depend on intra prediction mode, and only the first bin is context coded. Furthermore, LFNST is applied for intra CU in both intra and inter slices, and for both Luma and Chroma. If a dual tree is enabled, LFNST indices for Luma and Chroma are signaled separately. For inter slice (the dual tree is disabled), a single LFNST index is signaled and used for both Luma and Chroma.

Considering that a large CU greater than 64×64 is implicitly split (TU tiling) due to the existing maximum transform size restriction (64×64), an LFNST index search could increase data buffering by four times for a certain number of decode pipeline stages. Therefore, the maximum size that LFNST is allowed is restricted to 64×64. Note that LFNST is enabled with DCT2 only. The LFNST index signaling is placed before MTS index signaling.

The use of scaling matrices for perceptual quantization is not evident that the scaling matrices that are specified for the primary matrices may be useful for LFNST coefficients. Hence, the uses of the scaling matrices for LFNST coefficients are not allowed. For single-tree partition mode, chroma LFNST is not applied.

### Relevant Intra Block Copy and Template-Matching Based Intra Block Copy Methods:

### Intra Template Matching

Intra template matching prediction (Intra TMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

The prediction signal is generated by matching the L-shaped causal neighbor of the current block with another block in a predefined search area in figure below consisting of:
R1: current CTU
R2: top-left CTU
R3: above CTU
R4: left CTU
   Sum of absolute differences (SAD) is used as a cost function.
   Within each region, the decoder searches for the template that has least SAD with respect to the current one and uses its corresponding block as a prediction block.
   The dimensions of all regions (SearchRange_w, SearchRange_h) are set proportional to the block dimension (BlkW, BlkH) to have a fixed number of SAD comparisons per pixel. That is:

$$SearchRange\_w = a * BlkW$$

$$SearchRange\_h = a * BlkH$$

Where ‘α’ is a constant that controls the gain/complexity trade-off. In practice, ‘α’ is equal to 5.

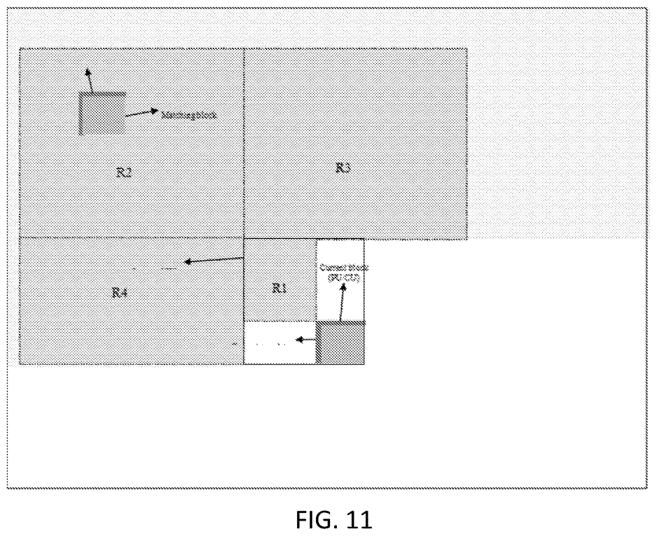

FIG. 11 illustrates an example Intra template matching search area used. The Intra template matching tool is enabled for CUs with size less than or equal to 64 in width and height. This maximum CU size for Intra template matching is configurable. The Intra template matching prediction mode is signaled at CU level through a dedicated flag when DIMD is not used for current CU.

Intra Block Copy (IBC) with Template Matching (TM)

Template Matching is used in IBC for both IBC merge mode and IBC AMVP mode.

The IBC-TM merge list is modified compared to the one used by regular IBC merge mode such that the candidates are selected according to a pruning method with a motion distance between the candidates as in the regular TM merge mode. The ending zero motion fulfillment is replaced by motion vectors to the left (−W, 0), top (0, −H) and top-left (−W, −H), where W is the width and H the height of the current CU.

In the IBC-TM merge mode, the selected candidates are refined with the Template Matching method prior to the rate-distortion optimization (RDO) or decoding process. The IBC-TM merge mode has been put in competition with the regular IBC merge mode and a TM-merge flag is signaled.

In the IBC-TM AMVP mode, up to 3 candidates are selected from the IBC-TM merge list. Each of those 3 selected candidates are refined using the Template Matching method and sorted according to their resulting Template Matching cost. Only the 2 first ones are then considered in the motion estimation process as usual.

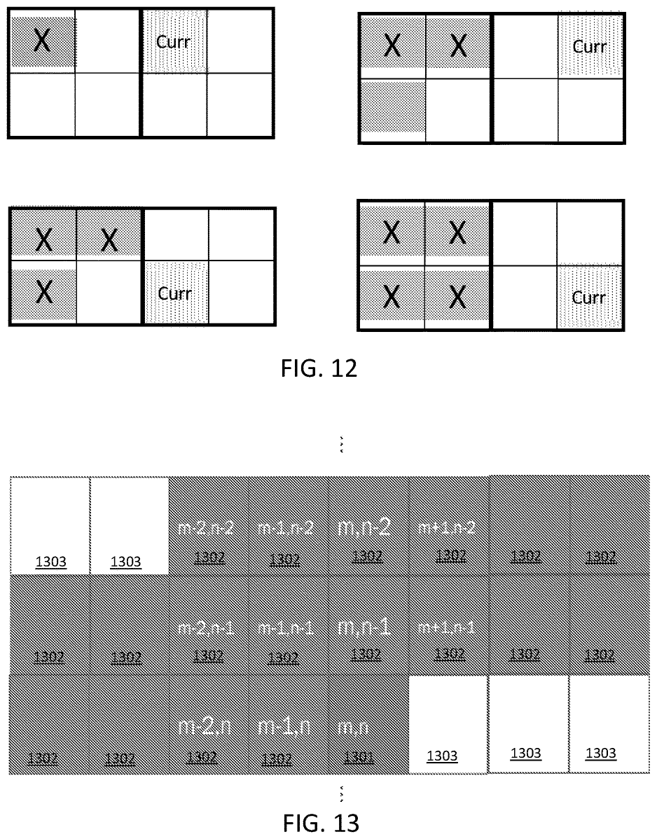

The Template Matching refinement for both IBC-TM merge and AMVP modes is quite simple since IBC motion vectors are constrained (i) to be integer and (ii) within a reference region as shown in FIG. 12; IBC reference region depending on current CU position. So, in IBC-TM merge mode, all refinements are performed at integer precision, and in IBC-TM AMVP mode, they are performed either at integer or 4-pel precision depending on the AMVR value. Such a refinement accesses only to samples without interpolation. In both cases, the refined motion vectors and the used template in each refinement step must respect the constraint of the reference region.

### IBC Reference Area

The reference area for IBC is extended to two CTU rows above. FIG. 13 illustrates the reference area for coding CTU (m,n); where the reference area for IBC when CTU (m,n) is coded: the block 1301 denotes the current CTU; blocks 1302 denote the reference area; and the blocks 1303 denote invalid reference area. Specifically, for CTU (m,n) to be coded, the reference area includes CTUs with index (m−2,n−2) . . . (W,n−2),(0,n−1) . . . (W,n−1),(0,n) . . . (m,n), where W denotes the maximum horizontal index within the current tile, slice or picture. When CTU size is 256, the reference area is limited to one CTU row above. This setting ensures that for CTU size being 128 or 256, IBC does not require extra memory in the current ETM platform. The per-sample block vector search (or called local search) range is limited to [−(C<<1), C>>2] horizontally and [−C, C>>2] vertically to adapt to the reference area extension, where C denotes the CTU size.

### Reconstruction-Reordered IBC (RR-IBC)

A Reconstruction-Reordered IBC (RR-IBC) mode is allowed for IBC coded blocks. When RR-IBC is applied, the samples in a reconstruction block are flipped according to a flip type of the current block. At the encoder side, the original block is flipped before motion search and residual calculation, while the prediction block is derived without flipping. At the decoder side, the reconstruction block is flipped back to restore the original block.

Two flip methods, horizontal flip and vertical flip, are supported for RR-IBC coded blocks. A syntax flag is firstly signaled for an IBC AMVP coded block, indicating whether the reconstruction is flipped, and if it is flipped, another flag is further signaled specifying the flip type. For IBC merge, the flip type is inherited from neighboring blocks, without syntax signaling. Considering the horizontal or vertical symmetry, the current block and the reference block are normally aligned horizontally or vertically. Therefore, when a horizontal flip is applied, the vertical component of the BV is not signaled and inferred to be equal to 0. Similarly, the horizontal component of the BV is not signaled and inferred to be equal to 0 when a vertical flip is applied.

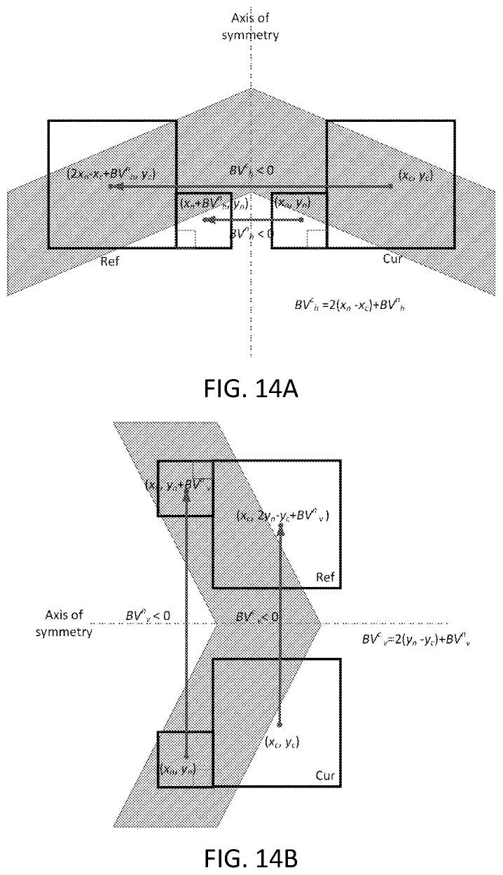

To better utilize the symmetry property, a flip-aware BV adjustment approach is applied to refine the block vector candidate. For example, as shown in figure below, (xnbr, ynbr) and (xcur, ycur) represent the coordinates of the center sample of the neighbouring block and the current block, respectively, BVnbr and BVcur denotes the BV of the neighbouring block and the current block, respectively. Instead of directly inheriting the BV from a neighbouring block, the horizontal component of BVcur is calculated by adding a motion shift to the horizontal component of BVnbr (denoted as BVnbrh) in case that the neighbouring block is coded with a horizontal flip, i.e., BVcurh=2(xnbr−xcur)+BVnbrh. Similarly, the vertical component of BVcur is calculated by adding a motion shift to the vertical component of BVnbr (denoted as BVnbrv) in case that the neighbouring block is coded with a vertical flip, i.e., BVcurv=2(ynbr−ycur)+BVnbrv. FIGS. 14A and 14B illustrate examples of BV adjustment for (a) horizontal flip, and (b) vertical flip, respectively

IBC Merge Mode with Block Vector Differences (IBC-MBVD)

Affine-MMVD and GPM-MMVD have been adopted to ECM as an extension of regular MMVD mode. It is natural to extend the MMVD mode to the IBC merge mode. In IBC-MBVD, the distance set is {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, and the BVD directions are two horizontal and two vertical directions. The base candidates are selected from the first five candidates in the reordered IBC merge list. And based on the SAD cost between the template (one row above and one column left to the current block) and its reference for each refinement position, all the possible MBVD refinement positions (20×4) for each base candidate are reordered. Finally, the top 8 refinement positions with the lowest template SAD costs are kept as available positions, consequently for MBVD index coding. The MBVD index is binarized by the rice code with the parameter equal to 1. An IBC-MBVD coded block does not inherit flip type from a RR-IBC coded neighbor block.

As noted above, Intra block copy tools generate prediction for the current block by copying most similar block as it is in reference area without adapting the data to the local texture. Copying the data without adapting it to the local texture could be useful when the texture in the frame is very simple and does not contain any noise, illumination change, or any other texture change in the local area compared to the reference region, which frequently happens in screen content. However, such behaviors do not occur often in the natural content. Particularly, camera captured images and videos usually contain texture changes in different regions due to illumination change, noise, blurring due to camera or object motion, coding artifacts, etc. Hence, only copying the data from a certain region in the frame may not always be able to provide efficient prediction. Features as described herein may be used in enhancing the intra block copy performance by adapting the copied samples to local samples.

Features as described herein may be used in example methods for improving the performance of the intra block copy tool. Features as described herein may use one or more filters for enhancing the performance of the IBC tool. In some example embodiments, one or more filters may be used for enhancing the performance of the IBC tool by adapting the texture of the reference area to the local area. In some example embodiments, one or more filters may be trained in both the encoder side and the decoder side using one or more of the reconstructed samples in the neighborhood of the block in reference area and the corresponding reconstructed samples in the neighborhood of the current block to be coded. In some example embodiments, one or more filters may be trained in the encoder side using one or more of the reconstructed and/or original/uncompressed samples in the reference areas and the parameters are signaled to the decoder. In some example embodiments, the IBC method may utilize template matching mechanism as part of the prediction process.

With features as described herein, various methods and embodiments may be provided for enhancing the performance of intra block copy (IBC) method. However, it needs to be understood that although the methods and example embodiments described herein may use intra block copy (IBC) and perhaps template matching based intra block copy methods, these are only examples of use cases. Features as described herein may be used with other prediction and coding tools with similar concepts, and are not limited to use with intra block copy and template matching based intra block copy methods.

For the IBC example, in the various parts herein, the term “first prediction” refers to the copied samples from the reference area in IBC and/or template matching based IBC mode. In the various parts herein, the term “final prediction” or “second prediction” refers to the result of the applying one or more of the example methods to the “first prediction”. In one example implementation option, generating the “first prediction” and the “second prediction” may be done sequentially in two or more stages. In another example implementation option, generating the “first prediction” and the “second prediction” may be done jointly or, at least partially, at a same time or process.

With features as described herein, prior to using a filter, the filter may need to be trained. This may include determining a training area for the filter. Examples regarding using one or more filter and training one or more filters are further described below. With features as described herein, a filter may be selected from a plurality of filters. Examples regarding selecting one or more filter are also further described below. Final use of a filter to code a current region/area/block may depend upon the type of filter selected and perhaps other information which use of the selected filter is dependent upon such as, for example, information from neighboring regions/areas/blocks which neighbor the current region/area/block to be coded.

The term “training” is used herein in regard to deriving or calculating the filter parameters using a set of reference samples. In this context training implies a process where filter parameters are derived. They may be derived with minimizing an error between reference samples and a set of target samples. In this example case, reference samples may be a set of samples (i.e., template) in the vicinity of a reference block, and target samples may be a set of samples (i.e., template) in the reconstructed neighborhood of the current block. The filter parameter calculation may use different methods for estimating the filter parameters such as, for example, regression-based methods with mean squared error (MSE) minimization. It should be noted that training may occur at the encoder side of the process(es), or at the decoder side of the process(es), or at both the encoder side and the decoder side of the process(es).

Two types of “training areas” are described herein. One type of “training area” is in regard to determining one or more filter parameters. Another type of “training area” is in regard to cost calculation such as, for example, for selecting a filter from a plurality of potential filters or creating a list of “reference” candidates or reference area candidates. The reference candidates may be reference blocks for example. As noted below, the training areas for the different steps may be the same, may be separated, or may be only partially the same (such as partially overlapping with being partially different).

Moreover, the terms reference area, template, template-matching, block vectors are used in the same or similar context as “intra template matching” and various “intra block copy” methods described above.

In an example embodiment, one or more filters may be applied to one or more samples of the first prediction from the intra block copy process. The filter parameters could be predefined, and/or they may be derived in the encoder side and/or the decoder side. In one type of example embodiment the filter parameters could be derived or determined at the decoder side using one or more of the reconstructed reference samples for example. In one type of example embodiment, deriving the filter parameters at the encoder side might use a reconstructed reference sample. If the parameter derivation is done in the encoder side only, then the process can use both reconstructed samples and original samples. Thus, there is a possibility of using either or both reconstructed samples and original samples for parameter derivation. In one example embodiment, the filter parameters could be entirely predefined and located at the encoder side and signaled to the decoder side in various granularities such as per block, picture, or sequence for example. In one example embodiment, several different set of filters could be predefined at encoder and decoder, and the decision on which filter will be applied for the current block could be done by both encoder and decoder using reconstructed samples. In one example embodiment, the filter parameters could be entirely predefined and located at the decoder side. In one example embodiment, determining the filter parameters could occur only at the encoder side and be signaled to the decoder side. In one example embodiment, determining the filter parameters could occur both at the encoder and decoder sides. In other example embodiments, the filter parameters could include only predetermined filter parameters, or only non-predetermined filter parameters, or a combination of predetermined filter parameters and non-predetermined filter parameters. These are merely some examples of possibilities.

Both encoder and decoder can use the reconstructed area to calculate the cost of each predefined set of filters by applying said filters on the template and calculating the difference. In another example embodiment, the filter selection maybe done through a different analysis on the reconstructed samples, such as determining the directionality of the texture over the template area through calculating gradients for example.

With the IBC example, the filtering process of the copied samples (i.e., the first prediction) from the reference area in IBC may be used in enhancing the compression efficiency of the final prediction by adapting the samples from the reference region (i.e., the region the samples are copied from) to the texture of the local region (i.e., the region in the neighborhood of current block) so that the prediction error is reduced. As noted above, features as described herein are not limited to an IBC process. Thus, the filtering process may comprise copying samples (i.e., the first prediction) from a reference region/area (i.e., a region/area which the samples are copied from) and then adapting or modifying the copied samples to the texture of a local region. The local region may be, for example, a region in a neighborhood of current region/area where the adapted/modified data is to be used. This current region/area may be the current block in the IBC example. This copying and modifying process may be used in enhancing the compression efficiency of a final prediction of what the current region/area should be. In the above example, this would include the modified texture to the copied sample. This may be used so that the prediction error is reduced. It should be noted that this modification is not necessarily limited to a texture modification. The process may be used to modify one or more features separate from texture or modify one or more features in addition to texture.

The filter(s) may be M-tap filter(s) trained using certain information available at the time of coding the current block, such as for example:
One or more of spatial reconstructed samples in the neighborhood of the current block,
One or more of spatial reconstructed samples in the neighborhood of the reference block,
One or more of spatial reconstructed samples in the neighborhood of a block other than the current or the reference block,
One or more of location information (e.g., horizontal and vertical coordinates) of spatial reconstructed samples in the neighborhood of the reference block,
One or more of location information (e.g., horizontal and vertical coordinates) of spatial reconstructed samples in the neighborhood of the current block,
One or more of gradient information of spatial reconstructed samples in the neighborhood of the current block,
One or more of gradient information of spatial reconstructed samples in the neighborhood of the reference block,
One or more of DC or average values of spatial reconstructed samples in the neighborhood of the current block,
One or more of DC or average values of spatial reconstructed samples in the neighborhood of the reference block,
A bias or offset value

An example of the M-tap filter is illustrated with:

$$pred = {P}_{0} \cdot {C}_{0} + {P}_{1} \cdot {C}_{1} + {P}_{2} \cdot {C}_{2} + … + {P}_{M - 2} \cdot {C}_{M - 2} + … + {P}_{M - 1} \cdot β$$

In the above formula:
pred is the output of the filtering process,
(P₀, . . . , P_{M-1}) are the filter parameters calculated based on the one or more available information described above,
(C₀, . . . , C_{M-2}) are the input information to the filter as described above, and
the β is the bias or offset value.

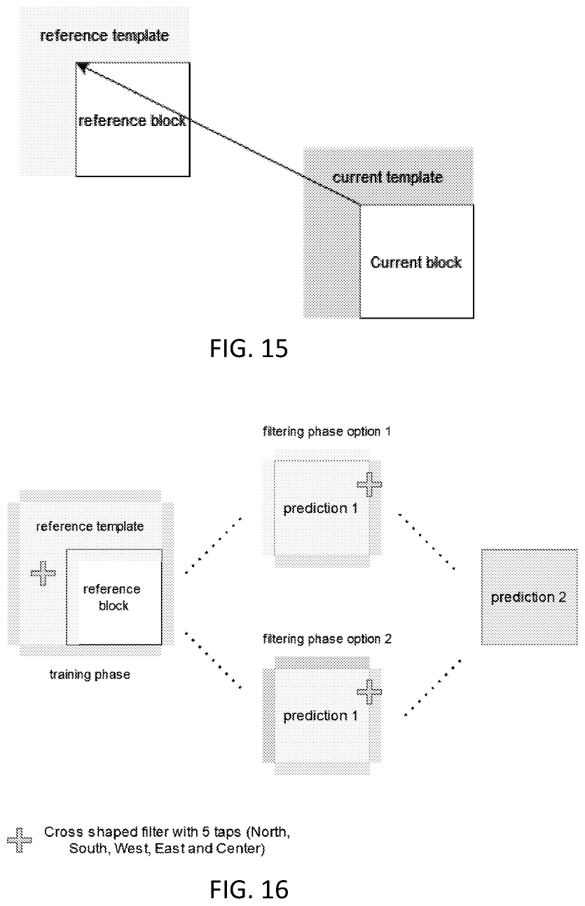

Examples of the different filter sizes are shown in FIG. 6. The C shows the center spatial sample, N, S, W, E show the north, south, west and east spatial samples, and so on. FIG. 15 shows an example reference block and the current block together with associated templates and a block vector in IBC. FIG. 16 shows an example illustrating first predictions where filtering phase options 1 and 2 are used, and a second prediction where:
the Left is the area showing the samples over which the training is applied,
the Middle-top is showing filtering the reference block using the samples around the reference block,
the Middle-bottom is showing filtering the reference block using samples from both around the current block and the reference block, and
the Right is showing the final prediction.

In one type of example embodiment, the filter parameters may be calculated in different units such as prediction unit (PU), coding unit (CU), coding tree unit (CTU), tile, slice, sub-picture, frame, sequence, etc.

In one type of example embodiment, one or more of the described inputs to the filter may be scaled up or down before using them in the filter. For example, their values may be multiplied by a constant number or divided by a constant number, or a shift to right or left operation may be applied instead of multiplication. In another example, a constant value may be added to or deducted from one or of the inputs to the filter.

According to the previous example embodiment, the modification of the filter inputs may be done adaptively. This could be for example done by analyzing the intensity range or one or more of the other inputs and then determine a modification parameter to be applied to one or more of the parameters. This could be helpful for example in balancing the intensity magnitudes of the input filters in order to have a better parameter calculation for the filter.

In one type of example embodiment, the gradient inputs may be calculated using one or more of the spatial samples. For example, they may be calculated by difference or weighted difference of one or more of the spatial samples. For example, the vertical gradient may be calculated by subtracting north sample from south sample (N-S), horizontal gradient may be calculated by subtracting west sample from east sample (W-E).

In one type of example embodiment, different filters may be trained in the encoder side and tested for the block. In one type of example embodiment, a best performing filter may be determined in terms of rate-distortion optimization (RDO). However, in alternate examples, a process other than, or in addition to, use of rate-distortion optimization (RDO) may be used to determine at least one best performing filter or better performing filter relative to performance of other filters. The best performing filter may be selected and indicated in a bitstream from the encoder side. This may be done, in one example embodiment, with using a corresponding index of that filter.

In one type of example embodiment, each filter may include one or more of the information as described above as inputs.

In one type of example embodiment, the filter may include nonlinear variants (e.g., power of two, square root, etc.) of the described information above as inputs.

In one type of example embodiment, a list of N reference candidates may be generated in the encoder and/or decoder side as reference regions or areas to be filtered; where “N” is an integer. For the IBC example, the list of N reference candidates may be generated in the encoder and/or decoder side as reference blocks (as reference regions or areas) to be filtered. Two or more of the N candidates in the list may have overlapping areas or they may be generated in such a way that they do not have any overlapping areas. In one type of example embodiment, the list may contain reference candidates with different block vectors in a certain distance from the current block in current frame. The list may be generated in one or more of any type of different ways. One example of a way of generating the list may use block vectors of the neighboring block to be considered when generating the list. One or more candidates in the list may be generated using the template-based search methods, such as where a template with a certain size in the neighborhood of the current block is defined and the best matching corresponding templates (templates with the least cost) in a certain search region is selected and added to the list as prediction candidates. For this purpose, the template cost may be calculated using the difference of samples in template of a current block and template of reference blocks. The template cost may be calculated, for example, using one or more of sum of absolute differences (SAD), sum of square errors (SSE), sum of absolute transform differences (SATD), or any other difference/distance measuring metrics. The potential candidates used to populate the list may be limited to a determined location, such as proximate the current block to be coded for example. So, entry into the list may be regulated or limited, such as being predetermined or determined another way. Creation of a list may be used to narrow or limit a number of potential candidates of reference regions/areas/blocks, and prioritize or order the selected candidates on that list. It should be noted that, in one type of example embodiment, a “list” need not be generated and used to filter one or more candidate reference regions/area/blocks to be used for modifying a copied reference (a copied reference region, a copied reference area, or a copied reference block for example). Filtering may occur with use of a “list” of candidate reference regions/area/blocks.

With the previous example embodiment which uses a list, the candidates in the list may be sorted such as, for example, in ascending order using the described template cost values or the entry to the list can be based on having a lower cost than the highest of the existing ones. In another example, the sorting of the candidates may be done based on their distance to the current block. In another example, the sorting of the candidates may be done based on both distance to the current block and the calculated cost of the candidates. It should be noted that these are merely examples.

In one type of example embodiment, the final list of candidates to be filtered can be generated such that the entry criteria to the list can be such that the diversity is sought. For this purpose, in addition to cost, block vectors may also be checked and similar cost and similar block vectors may be avoided in an initial list, but later refinement may be applied on the initial candidates to generate the final list. The refinement process may include adding an offset value to one or both of the horizontal and vertical coordinates of the block vectors of the candidates. The offset values may be predefined, or they may be defined based on for example the distance of the candidates block vector to the current block, dimensions of the block, etc.

In one type of example embodiment, the filter parameters may be generated based on one or more candidates in the list, then the refinement search is done as described above but using the same filter parameters as previously generated to find the best refined candidate.

In one type of example embodiment, two or more separate lists may be generated. For example, each list may contain candidates found through a template-matching based search, but using different cost measuring methods. For example, list_0 may generate N candidates using SAD cost, and list_1 may generate N candidates with SSE cost. Different filters may be generated accordingly for the candidates in each list. The final candidate, and its corresponding filter(s) for predicting the block and applying the filter, may be done using either or both metrics, or a separate metric for template cost calculation. These are merely examples.

According to this previous example embodiment, the final prediction of the block may be obtained, for example, by a weighted combination of the outputs of best performing filters from each list, or output of the best performing filter and the unfiltered reference.

In an example embodiment, the final prediction of the block may be obtained by applying more than one filter in more than one steps. For example, the first prediction of the block may be obtained using the IBC method (i.e., copying samples from the reference block). One filter may be applied to the first prediction in order to obtain the second prediction. A second filter may be applied to the second prediction in order to obtain the third prediction where the third prediction may reduce the prediction error compared to the second and/or the first prediction. The final prediction of the block may be the third prediction, or it may be a combined version of the third prediction with first prediction and/or the second prediction.

In one type of example embodiment, the cost measure can be a combination of different cost measures in order to better utilize the different features of difference/distance metrics. For example, the total cost for a candidate can be a weighted sum of SAD and SSE. In this case, for example, a single list may be generated in ascending order of the combined cost values.

In one type of example embodiment, the best performing filter may be determined in both an encoder side and a decoder side using the template cost of the filtered template area of the reference. For example, the template area may be selected in the neighborhood of the current block as well as corresponding area in the reference block. One or more trained filters may be applied to the template area of the reference block, and the difference/distance of the filtered samples in this area to the reconstructed ones in the template area of the current block may be measured using one or more cost terms, such as SAD and SSE for example. The best performing filter that minimizes the cost in the template area may be selected and used for filtering the prediction block.

With the previous example embodiment, the training area for the filters may be the same template area for the cost calculation. Alternatively, the training area and template area for cost calculation may differ or they may have some overlapping parts. For example, the training may use left side reference samples for parameter derivation, and the cost calculation process may use above side template samples as reference. In a different approach, the template area for cost calculation may be a subset of a training area. Alternatively, cost calculation can be done on the samples nearest to the current block to be coded to be most representative, whereas training is done on the further away ones and overlap is avoided.

In one type of example embodiment, the choice of either or both training area and cost calculation area may be indicated in a bitstream from the encoder side to the decoder side. As an alternative example embodiment, such selection could be determined in the decoder side, for example using the cost values as indicators for the best training area.

In one type of example embodiment, a pre-processing operation may be applied to the some or all of the template samples used for the filter calculation. The pre-processing may be, for example, a smoothening operation, sharpening operation, denoising operation, resampling (for example down-sampling or up-sampling) operation, etc.

In one type of example embodiment, one or more candidates in the list may be refined by adding some type of block vector difference to them. A candidate for the final prediction process, such as the best candidate, may be selected according to the template cost after filtering. Moreover, the cost term in the refinement phase may differ from the template-matching based cost term in the list generation process. For example, the candidates list may be generated by template matching based method using SAD cost, but the refinement part may refine those candidates in the list using SSE cost, or vice versa.

In one type of example embodiment, the filter size and/or type may be determined using the template cost values. For example, if a certain filter type causes an increase in the template cost compared to unfiltered version, then the method may switch to a different type of filter (for example a simpler filter with less number of taps or more complex filter defined in the algorithm).

According to another example embodiment, two or more filter types may be derived and tested for the first candidate in the list. The best performing filter type may be determined according to the template costs of said filters for the first candidate. The determined best filter type from this process may then be considered for the remaining candidates in the list.

According to another example embodiment, the filter type and/or parameters may be inherited from one or more of the neighboring blocks that are coded using the method as described herein.

In one type of example embodiment, the filter size and/or type may be determined using the block vector values for the intra block copy process. For example, simpler filters may be used for the reference blocks in the certain distance of the current block or vice versa. The distance and/or direction may be defined in the method or signaled in the bitstream in different units for example PU, CU, CTU, slice, picture.

In one type of example embodiment, more than one filter may be selected to be applied for the first prediction. In this case, the final prediction may be the result of blending two or more filters' outputs. The blending weights for this process may be fixed. For example, they may be predefined in the method or signaled in the bitstream. The blending weights may be determined in the decoder side using the template-based selection approach described in previous embodiment. In this case, multiple sets of blending weights may be applied to combine outputs of two or more filters in the template area, and the best weight set that minimizes the error may be selected and applied for blending of the outputs of multiple filters in the current block.

In one type of example embodiment, the outputs of one or more filters may be blended or combined with the unfiltered samples. The weight values may be determined using similar methodologies as a previous example embodiment.

In one type of example embodiment, the filter type and/or size and/or filter input types may be determined based on certain information such as, for example, block size, availability of reference samples in the neighborhood of the current block and/or neighborhood of the reference block.

In one type of example embodiment, the filter may be applied only in a certain region or samples of the block. For example, if the filter results in larger costs in certain parts of the defined template, then this may indicate that the filter may not perform well also in the samples of current block with similar characteristics. In such cases, the samples of the current block with similar characteristics as the template region with large cost may be excluded from the filtering process. In an alternate example, final prediction in those regions may be obtained by combining the filtered and unfiltered samples and assigning lower weights to the output of the filtered samples.

In one type of example embodiment, two or more filters may be derived for different sample intensity ranges in the template area and applied to the corresponding samples in those ranges in the current block. For example, two filters may be calculated from the reference areas such as, for example, one filter for samples smaller than a certain threshold and one filter for remaining samples. The threshold could be, for example, average samples values in the template.

In one type of example embodiment, an outlier removal process may be conducted to the training samples in order to exclude the ones which do not correlate well with the rest of the samples in the training area and/or in the reference block. The correlation of samples may be identified via various means, for example, if the texture characteristics do not align well with other regions or intensity range is highly different compared to other regions. This may be done in various ways such as, for example, using the mean value of the samples in the reference block as a parameter to exclude the samples which are in certain threshold of the said mean value. The outlier removal process may use template cost as an indication of the uncorrelated samples for the training phase. For example, if the cost in a certain region in a template is larger than the rest of the template area, then it may indicate that the samples in that region may not correlate well and can be excluded from the filter parameter calculation part.

In one type of example embodiment, the decision for applying the filter for an IBC block may be decided using information from the co-located block in a reference channel. For example, for a chroma block, if the co-located luma block is coded using filtered IBC (i.e., the method as described herein), then the chroma block may also use same block vectors, with possible scaling, to do the final prediction. Similarly, filter information (e.g., filter type, size, parameters, etc.) may be also inherited from the co-located luma block. Moreover, the signaling of the chroma IBC may also depend on the co-located luma mode.

According to this previous example embodiment, if there are more than one filtered IBC blocks in the co-located luma region, then a list of candidates may be generated accordingly from those blocks. The best candidate with best filtering process may be determined using the candidates in the list and a template-based methods. In one type of alternative, the best candidate from the list may be selected in the encoder side and an index indicating the candidate in that list may be signaled in the bitstream.

In one type of example embodiment, when filtering the IBC block, it can be filtered in the reference area; meaning that on the borders of the block to be filtered, the filter may use the reference samples of the reference block whenever they are available. For example for a 5-tap cross shaped filter, the process of filtering may make use of the reconstructed area one line above, to the right, to the left and to the bottom of the reference block.

According to another example embodiment, whenever these samples are unavailable to the process, the filter can pad these samples with the surrounding closest available samples, or it can interpolate the value of these samples.

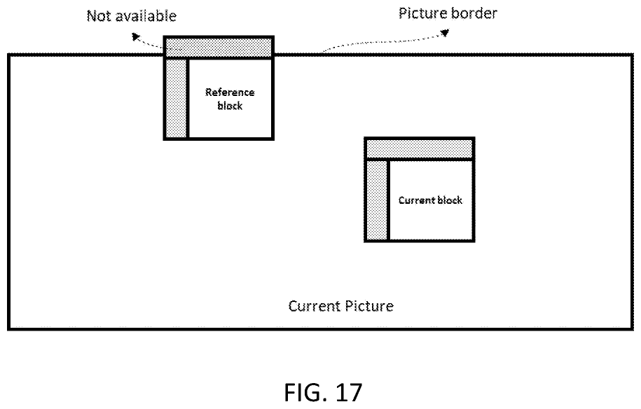

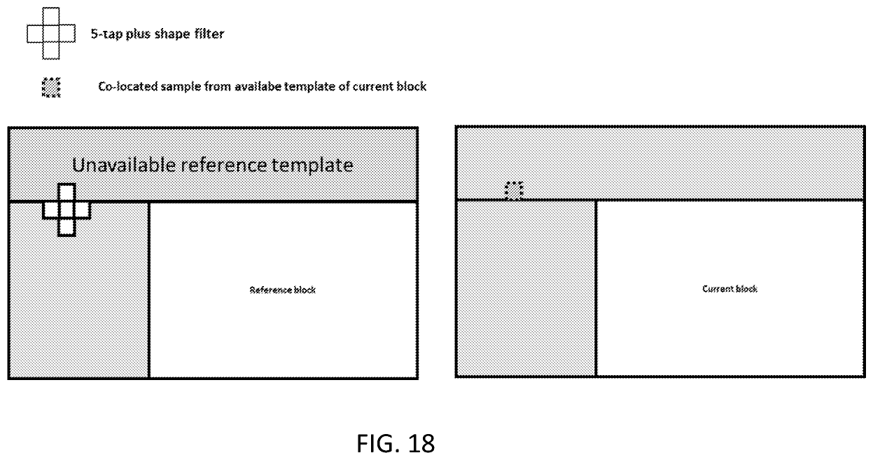

According to another example embodiment, if one or more of the filter taps point to an area of the frame that is not available (either in training, or validation or both), then the corresponding sample may be used from the co-located area of the other template. For example, in FIG. 17, the above reference template is not available when training the filter parameters, thus, only the left side template samples are used. However, one or more of the filter taps may point to outside of the left template as shown in FIG. 18. In such cases, instead of padding the immediate available sample to be used in the unavailable tap, the method may use the corresponding available sample from the other template.

In one type of example embodiment, the IBC block can be filtered in the current block area; meaning that the prediction may be treated such that the top and left reference lines of the block may be the reference lines of the current block. In this example scenario, because the right and bottom reference lines of the current block are not available, those can be copied from the reference area (right and bottom reference lines of the reference block) or those can be padded from the top right and bottom left samples.

In one type of example embodiment, during the filter training process, samples that lie on the border of the available area can be either padded or can be omitted. For example, in the case when there are enough samples to train the filter without these samples, samples that lie on the border of the available area can be either padded or can be omitted.

In one type of example embodiment, the search for matching block in the IBC method may use the first cost value based on the IBC search method to obtain the first prediction, and then a second cost value may be calculated using the filtered samples in the template in order to determine the final prediction. In an example alternative approach, the first cost calculation process may be bypassed and the second cost calculation process based on the filtered template samples may be used in order to determine the final prediction.

The final prediction of the block may use one or more of the methods described in the various example embodiments described herein.

In one type of example embodiment, one or more of the filter types, filter inputs, filter size may be determined based on the underlying content to be coded. For example, for screen content it may be decided to use a certain type of filter to be calculated and/or applied and for camera captured content another type of filter may be decided to be calculated and/or applied from the defined sets of filter types. As another example, for screen content one or more linear models may be decided to be used, and for camera captured content one or more complex filter types may be decided to be used. This may be determined in the encoder side and is indicated for example in the sequence parameter set or picture parameter set of the underlying codec.

It needs to be understood that the methods and embodiments described herein may use intra block copy and template matching based intra block copy methods as examples of the use cases, and the methods may can be applied to any other prediction and coding tools with similar concepts.

In one type of example embodiment, the method and apparatus may be configured such that the filter parameters are neither derived nor received. Instead, the filter to be used is selected from a predefined set of filters by applying these filters over the template area and picking the one with the least cost. In this scenario, there is no signaling, and both the encoder and the decoder may determine the filter to be used by cost calculation over the template area.

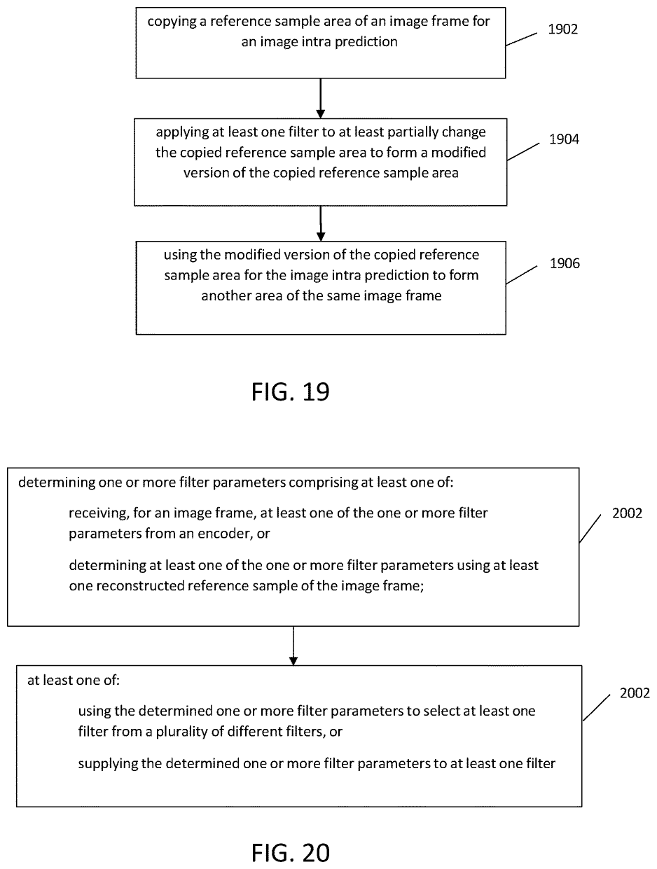

Referring also to FIG. 19, in accordance with one example embodiment, a method is provided comprising: copying a reference sample area of an image frame for an image intra prediction as indicated by block 1902; applying at least one filter to at least partially change the copied reference sample area to form a modified version of the copied reference sample area as indicated by block 1904; and using the modified version of the copied reference sample area for the image intra prediction to form another area of the same image frame as indicated by block 1906.

The image intra prediction may be part of an intra block copy (IBC) process. The applying of the at least one filter to at least partially change the copied reference sample area to form the modified version of the copied reference sample area may cause a texture of the modified version of the copied reference sample area to be changed versus the texture of the copied reference sample area. The applying of the at least one filter may comprise applying two or more filters to at least partially change the copied reference sample area to form the modified version of the copied reference sample area. The method may comprise using a template matching process as part of the image intra prediction to form the another area of the same image frame. The method may comprise calculating one or more filter parameters in the encoder and/or the decoder side using the template of samples defined in the neighborhood of the current block and/or neighborhood of the reference block. The method may comprise receiving one or more filter parameters from an encoder, and using the one or more filter parameters with the applying of the at least one filter. The receiving of the one or more filter parameters from the encoder may comprise receiving at least one of: at least one predefined filter parameter, or at least one non-predefined filter parameter derived or calculated with the encoder using at least one of: one or more reconstructed reference samples, or one or more original or uncompressed reference samples. The method may comprise at least one of: receiving one or more first filter parameters from an encoder, or determining one or more second filter parameters using one or more reconstructed reference samples; and using the one or more filter parameters with the applying of the at least one filter.

The applying of the at least one filter may comprise using information, available at a time of coding a current block, comprising at least one of: one or more of spatial reconstructed samples in a neighborhood of the current block, one or more of spatial reconstructed samples in a neighborhood of a reference block, one or more of spatial reconstructed samples in the neighborhood of a block other than the current and other than the reference block, one or more of location information of spatial reconstructed samples in the neighborhood of the reference block, one or more of location information of spatial reconstructed samples in the neighborhood of the current block, one or more of gradient information of spatial reconstructed samples in the neighborhood of the current block, one or more of gradient information of spatial reconstructed samples in the neighborhood of the reference block, one or more of direct coding (DC) or average values of spatial reconstructed samples in the neighborhood of the current block, one or more of direct coding (DC) or average values of spatial reconstructed samples in the neighborhood of the reference block, or a bias or offset value. The applying of the at least one filter may comprise generating a list of reference candidates as reference blocks to be filtered. The list may be limited to contain reference candidates with different block vectors a certain distance from a current block in the image frame. The list may be generated in different ways including using block vectors of a neighboring block. One or more candidates in the list may be generated using a template-based search method, where a template with a certain size in a neighborhood of the current block is defined, and a best matching corresponding template in a certain search region is selected and added to the list as a prediction candidate. A template cost may be calculated using a difference of samples in a template of the current block and a template of reference blocks. A template cost may be calculated using one or more of sum of absolute differences (SAD), sum of square errors (SSE), or any other difference measuring metrics or distance measuring metric. The list of candidates to be filtered may be generated based upon an entry criteria to the list. The entry criteria may comprise a template cost and, block vectors, where the template cost and the block vectors may be checked such that similar cost and similar block vectors are avoided in an initial list, and later refinement is applied on initial candidates of the list. The generating of the list may comprise generating at least two lists, where the at least two lists contain candidates found through template-matching based search, where the candidates for the at least two lists are found using respective different cost measuring methods for the at least two lists. Different filters may be generated for the candidates in each list. A final candidate and its corresponding filter(s) for predicting the block, and applying the filter, may be done using at least one of: metrics, or a separate metric for template cost calculation. A final prediction of the current block may be obtained by a weighted combination of: outputs of best performing filters from each list, or output of the best performing filter and an unfiltered reference.

A template cost measure may be determined comprising a combination of different cost measures using different features of difference metrics or distance metrics to form combined cost values, and the list may comprise a single list generated in ascending order of the combined cost values. Candidates for the list may be determined based, at least partially, upon a template cost of a template area of a reference. The template area may be selected in a neighborhood of a current block and a corresponding area in the reference. The at least one filter may be applied to the template area of the reference, and a difference or distance of filtered samples in the template area to reconstructed samples in the template area of the current block may be measured using one or more cost terms. A best performing filter that minimizes the cost in the template area may be selected and used for filtering. A training area for the at least one filter may be a same template area for the cost calculation. A training area for the at least one filter and a template area for the cost calculation may partially overlap. A training area for the at least one filter and a template area for the cost calculation may not overlap. The method may comprise receiving, in a bitstream, at least one of: an indication of a training area for the at least one filter, or an indication of a cost calculation area for the template cost of the template area. The method may comprise selecting at least one of a training area for the at least one filter or a cost calculation area for the template cost of the template area based upon cost values as indicators for a best training area. The method may comprise adding a block vector difference to one or more candidates in the list. The method may comprise selecting a best candidate for a final prediction process of the image intra prediction based, at least partially, upon a cost term after filtering used in a refinement phase. The template cost used for determining the candidates of the list may be different from the cost term used in the refinement phase. At least one of a filter size or filter type may be determined using the template cost. The method may comprise using at least two filter types for testing a first one of the candidates of the list to select one of the at least two filter types based upon respective template costs for the at least two filter types; and using the selected filter type to filter at least one other remaining one of the candidates on the list.

The method may comprise using at least one of: a filter type, or a filter parameter, from one or more neighboring blocks for applying the at least one filter. The method may comprise determining at least one of a filter size or a filter type using a block vector value. The applying of the at least one filter may comprise a first prediction and a second prediction, where more than one filter is selected to be applied for the first prediction, and the second prediction comprises a blending of two or more filters outputs from the first prediction. Blending weights for the blending may be fixed. The fixed blending weights may be one of: predefined or signaled in a bitstream. Blending weights for the blending may be determined using a template based selection. Multiple sets of the blending weights may be applied to combine the outputs of two or more filters in a template area, and a weight set for minimizing an error is selected and applied for the blending of the outputs for a current block. The method may comprise combining or blending the outputs from the first prediction with unfiltered samples.

The method may comprise determining at least one of a filter size or a filter type based upon at least one of: block size, availability of reference samples in a neighborhood of a current block, or availability of reference samples in a neighborhood of a reference block. In the intra block copy (IBC) process, the applying of the at least one filter may comprise applying of the at least one filter to a portion of a block which is less than all of the block. The method may comprise combining the modified version of the copied reference sample area with an unfiltered sample, with assigning a lower combining weight to the modified version of the copied reference sample area for an output. The at least one filter may comprise two or more filters derived for different sample intensity ranges in a template area, and applied to the corresponding samples in those ranges in a current block. The two or more filters may be determined from reference areas, where a first one of the two or more filters is used for samples smaller than a threshold, and a second one of the two or more filters is used for at least one other remaining one of the samples. The threshold may be an average of samples values in the template area.

The method may comprise training the at least one filter with training samples; and applying an outlier removal process to exclude one or more of the training samples from the training based upon at least one of: correlation relative to other ones of the training samples in a training area, or a reference block. The correlation may comprise determining when a texture characteristic does not align with other regions a determined amount, or when an intensity range is different compared to the other regions above a determined amount. The outlier removal process may comprise use of a template cost as an indication of uncorrelated samples for a training phase.

The method may comprise determining to apply the at least one filter, where a decision for the applying of the at least one filter for an IBC block is at least partially decided using information from a co-located block in a reference channel. When the IBC block is a chroma block, and the co-located block is a luma block coded using filtered IBC, then the chroma block may use same block vectors as the luma to perform a final prediction. The method may comprise using scaling when using information from the co-located block. The method may comprise using filter information from the co-located luma block for the chroma block. The method may comprise signalling of the chroma block depend on the co-located luma mode. The method may comprise, based upon there being more than one filtered IBC block in the co-located luma region, generating a list of candidates and, at least one of: determining a best filtering process candidate using the list of candidates in the list and a template-based method; or receiving a signal in a bitstream, and selecting one of the candidates from the list based upon the signal and an index indicating the candidate is signaled in the bitstream. The applying of the at least one filter may comprise filtering an IBC block comprising filtering limited to borders of the IBC block. Based upon at least one sample for the boarders being unavailable, the applying of the at least one filter may comprise at least one of: use a surrounding closest available sample for the unavailable sample, or interpolate a value of the unavailable sample. Based upon the IBC block being filtered in a current block, where the image intra prediction comprises a top reference line and a left reference line of the IBC block as reference lines of a current block, where a right reference line and a bottom reference line of the current block are unavailable, the method may comprise: copying a right reference line and a bottom reference line being copied from a reference area of a reference block for the right reference line and the bottom reference line for the current block, or padding the right reference line and the bottom reference line of the current block based upon a top-right sample and bottom-left sample. The method may comprise training the at least one filter, where when enough first samples are available that lie on the boarder for the training, allowing padding or omitting of other second samples for the training.

The method may comprise searching for a matching block in the IBC process comprising: using a first cost value to obtain a first prediction, and using a second cost value to calculate using filtered samples in a template in order to determine a final prediction. The method may comprise searching for a matching block in the IBC process comprising: bypassing a first cost calculation process; and using a second cost calculation process, based on filtered template samples, in order to determine a final prediction.

An example embodiment may be provided with an apparatus comprising: at least one processor; and at least one non-transitory memory storing instructions that, when executed with the at least one processor, cause the apparatus to perform: copying a reference sample area of an image frame for an image intra prediction; applying at least one filter to at least partially change the copied reference sample area to form a modified version of the copied reference sample area; and using the modified version of the copied reference sample area for the image intra prediction to form another area of the same image frame.

An example embodiment may be provided with an apparatus comprising: means for copying a reference sample area of an image frame for an image intra prediction; means for applying at least one filter to at least partially change the copied reference sample area to form a modified version of the copied reference sample area; and means for using the modified version of the copied reference sample area for the image intra prediction to form another area of the same image frame.

An example embodiment may be provided with a non-transitory computer readable medium comprising program instructions that, when executed with an apparatus, cause the apparatus to perform at least the following: copying a reference sample area of an image frame for an image intra prediction; applying at least one filter to at least partially change the copied reference sample area to form a modified version of the copied reference sample area; and using the modified version of the copied reference sample area for the image intra prediction to form another area of the same image frame.

An example embodiment may be provided with an apparatus comprising: circuitry configured for copying a reference sample area of an image frame for an image intra prediction; circuitry configured for applying at least one filter to at least partially change the copied reference sample area to form a modified version of the copied reference sample area; and circuitry configured for using the modified version of the copied reference sample area for the image intra prediction to form another area of the same image frame.

Referring also to FIG. 20, an example embodiment may be provided with a method comprising: determining as indicated by block 2002 one or more filter parameters comprising at least one of: receiving, for an image frame, at least one of the one or more filter parameters from an encoder, or determining at least one of the one or more filter parameters using at least one reconstructed reference sample of the image frame; and as indicated by block 2004 at least one of: using the determined one or more filter parameters to select at least one filter from a plurality of different filters, or supplying the determined one or more filter parameters to at least one filter, where the at least one filter is configured to at least partially change information from a copied reference sample area, from the image frame, to form a modified version of the copied reference sample area for use in a current area to be coded.

The method may comprise using the one or more filter parameters with a filtering process, where the filtering process comprises applying the at least one filter with the determined one or more filter parameters to at least partially change the information from the copied reference sample area, from the image frame, to form the modified version of the copied reference sample area for use in the current area to be coded. The method may comprise training the at least one filter at a decoder.

An example embodiment may be provided with an apparatus comprising: at least one processor; and at least one non-transitory memory storing instructions that, when executed with the at least one processor, cause the apparatus to perform: determining one or more filter parameters comprising at least one of: receiving, for an image frame, at least one of the one or more filter parameters from an encoder, or determining at least one of the one or more filter parameters using at least one reconstructed reference sample of the image frame; and at least one of: using the determined one or more filter parameters to select at least one filter from a plurality of different filters, or supplying the determined one or more filter parameters to at least one filter, where the at least one filter is configured to at least partially change information from a copied reference sample area, from the image frame, to form a modified version of the copied reference sample area for use in a current area to be coded.

An example embodiment may be provided with an apparatus comprising: means for determining one or more filter parameters comprising at least one of: receiving, for an image frame, at least one of the one or more filter parameters from an encoder, or determining at least one of the one or more filter parameters using at least one reconstructed reference sample of the image frame; and at least one of: means for using the determined one or more filter parameters to select at least one filter from a plurality of different filters, or means for supplying the determined one or more filter parameters to at least one filter, where the at least one filter is configured to at least partially change information from a copied reference sample area, from the image frame, to form a modified version of the copied reference sample area for use in a current area to be coded.

An example embodiment may be provided with a non-transitory computer readable medium comprising program instructions that, when executed with an apparatus, cause the apparatus to perform at least the following: determining one or more filter parameters comprising at least one of: receiving, for an image frame, at least one of the one or more filter parameters from an encoder, or determining at least one of the one or more filter parameters using at least one reconstructed reference sample of the image frame; and at least one of: using the determined one or more filter parameters to select at least one filter from a plurality of different filters, or supplying the determined one or more filter parameters to at least one filter, where the at least one filter is configured to at least partially change information from a copied reference sample area, from the image frame, to form a modified version of the copied reference sample area for use in a current area to be coded.

An example embodiment may be provided with an apparatus comprising: circuitry configured for determining one or more filter parameters comprising at least one of: receiving, for an image frame, at least one of the one or more filter parameters from an encoder, or determining at least one of the one or more filter parameters using at least one reconstructed reference sample of the image frame; and at least one of: circuitry configured for using the determined one or more filter parameters to select at least one filter from a plurality of different filters, or circuitry configured for supplying the determined one or more filter parameters to at least one filter, where the at least one filter is configured to at least partially change information from a copied reference sample area, from the image frame, to form a modified version of the copied reference sample area for use in a current area to be coded.

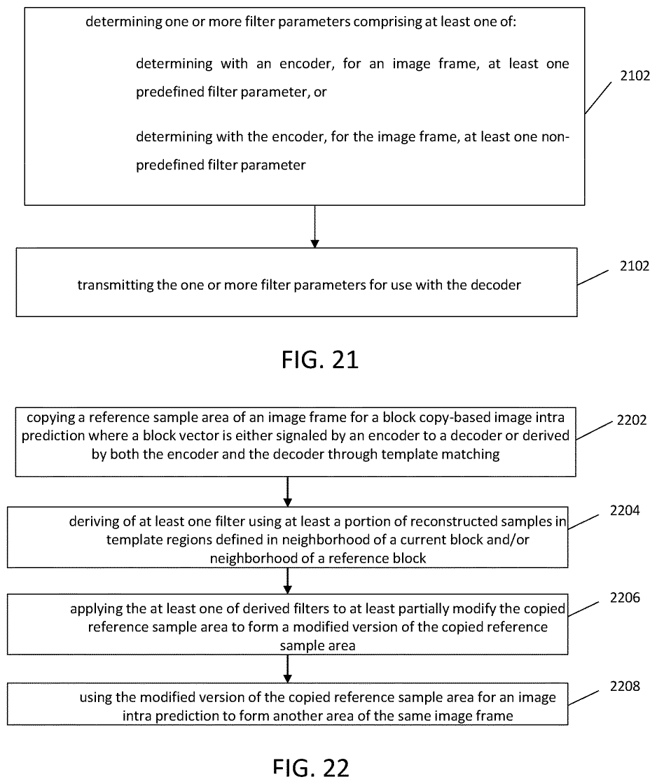

Referring also to FIG. 21, an example embodiment may be provided with a method comprising: determining as indicated by block 2102 one or more filter parameters comprising at least one of: determining with an encoder, for an image frame, at least one predefined filter parameter, or determining with the encoder, for the image frame, at least one non-predefined filter parameter, where the one or more filter parameters are configured for use with a decoder for a filtering process, where the filtering process comprises applying at least one filter to at least partially change a copied reference sample area, from the image frame, to form a modified version of the copied reference sample area; and transmitting the one or more filter parameters for use with the decoder as indicated by block 2104.

The one or more filter parameters may be configured for use with a selection process for selecting the at least one filter from a plurality of different filters. The one or more filter parameters may be configured to be used with one or more additional filter parameters determined at the decoder to at least one of: select the at least one filter from a plurality of different filters at the decoder, or use the filter parameters with the at least one filter at the decoder.

Referring to FIG. 22, an example embodiment may be provided with a method comprising: copying a reference sample area of an image frame for a block copy-based image intra prediction where a block vector is either signaled by an encoder to a decoder or derived by both the encoder and the decoder through template matching at indicated by block 2202; deriving of at least one filter using at least a portion of reconstructed samples in template regions defined in neighborhood of a current block and/or neighborhood of a reference block as indicated by block 2204; applying the at least one of derived filters to at least partially modify the copied reference sample area to form a modified version of the copied reference sample area as indicated by 2206; and using the modified version of the copied reference sample area for an image intra prediction to form another area of the same image frame as indicated by 2208.

An example embodiment may be provided with an apparatus comprising: at least one processor; and at least one non-transitory memory storing instructions that, when executed with the at least one processor, cause the apparatus to perform: determining one or more filter parameters comprising at least one of: determining with an encoder, for an image frame, at least one predefined filter parameter, or determining with the encoder, for the image frame, at least one non-predefined filter parameter, where the one or more filter parameters are configured for use with a decoder for a filtering process, where the filtering process comprises applying at least one filter to at least partially change a copied reference sample area, from the image frame, to form a modified version of the copied reference sample area; and transmitting the one or more filter parameters for use with the decoder.

An example embodiment may be provided with an apparatus comprising: means for determining one or more filter parameters comprising at least one of: determining with an encoder, for an image frame, at least one predefined filter parameter, or determining with the encoder, for the image frame, at least one non-predefined filter parameter, where the one or more filter parameters are configured for use with a decoder for a filtering process, where the filtering process comprises applying at least one filter to at least partially change a copied reference sample area, from the image frame, to form a modified version of the copied reference sample area; and means for transmitting the one or more filter parameters for use with the decoder.

An example embodiment may be provided with an apparatus comprising: circuitry configured for determining one or more filter parameters comprising at least one of: determining with an encoder, for an image frame, at least one predefined filter parameter, or determining with the encoder, for the image frame, at least one non-predefined filter parameter, where the one or more filter parameters are configured for use with a decoder for a filtering process, where the filtering process comprises applying at least one filter to at least partially change a copied reference sample area, from the image frame, to form a modified version of the copied reference sample area; and circuitry configured for transmitting the one or more filter parameters for use with the decoder.

An example embodiment may be provided with a non-transitory computer readable medium comprising program instructions that, when executed with an apparatus, cause the apparatus to perform at least the following: determining one or more filter parameters comprising at least one of: determining with an encoder, for an image frame, at least one predefined filter parameter, or determining with the encoder, for the image frame, at least one non-predefined filter parameter, where the one or more filter parameters are configured for use with a decoder for a filtering process, where the filtering process comprises applying at least one filter to at least partially change a copied reference sample area, from the image frame, to form a modified version of the copied reference sample area; and transmitting the one or more filter parameters for use with the decoder.

The term “non-transitory,” as used herein, is a limitation of the medium itself (i.e., tangible, not a signal) as opposed to a limitation on data storage persistency (e.g., RAM vs. ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(iii) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The following abbreviations that may be found in the specification and/or the drawing figures are defined as follows:
1D one dimension(al)
2D two dimension(al)
CCCM Convolutional Cross-Component Model
CTU Coding Tree Unit
CU Coding Unit
DC a mode where all samples in a prediction block have the same value
ECM Enhanced Compression Mode
JVET Joint Video Experts Team
IBC Intra Block Copy
I/F interface
MIP Matrix weighted Intra Prediction
N/W or NW network
PDPC Position Dependent Intra Prediction Combination
VVC Versatile Video Coding

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

1-27. (canceled)

28. A method comprising:
copying a reference sample area of an image frame for a block copy-based image intra prediction where a block vector is either signaled by an encoder to a decoder or derived by both the encoder and the decoder through template matching;
deriving of at least one filter using at least a portion of reconstructed samples in template regions defined in neighborhood of a current block and/or neighborhood of a reference block;
applying the at least one of derived filters to at least partially modify the copied reference sample area to form a modified version of the copied reference sample area; and
using the modified version of the copied reference sample area for an image intra prediction to form another area of the same image frame.

29. The method as claimed in claim 28, wherein deriving parameters of the at least one filter and/or applying the at least one filter comprises using information available at a time of coding the current block comprising at least one of:
one or more of spatial reconstructed samples in a neighborhood of the current block;
one or more of spatial reconstructed samples in a neighborhood of the reference block;
one or more of spatial reconstructed samples in a neighborhood of a block other than the current block and other than the reference block;
one or more of location information of the spatial reconstructed samples in the neighborhood of the reference block;
one or more of location information of the spatial reconstructed samples in the neighborhood of the current block;
one or more of gradient information of the spatial reconstructed samples in the neighborhood of the current block;
one or more of gradient information of the spatial reconstructed samples in the neighborhood of the reference block;
one or more of direct coding (DC) or average values of the spatial reconstructed samples in the neighborhood of the current block;
one or more of direct coding (DC) or average values of the spatial reconstructed samples in the neighborhood of the reference block; or
a bias or an offset value.

30. The method as claimed in claim 28, wherein the derivation of the at least one filter comprises determining filter coefficients based on minimization of an error.

31. The method as claimed in claim 28, wherein applying the at least one filter comprises:
generating a list of reference candidates as reference blocks to be filtered;
deriving filter parameters for each candidate reference block;
applying the at least one filter on a template area of the reference block;
calculating a template cost using a metric based on difference of samples in a template of the current block and a template of reference blocks; and
selecting a block/filter pair based on the template cost.

32. The method as claimed in claim 31, wherein the template cost is calculated using one or more of sum of absolute differences (SAD), sum of square errors (SSE), any other difference measuring metrics, or a distance measuring metric.

33. The method as claimed in claim 28 further comprising determining to apply the at least one filter, wherein a decision for the applying the at least one filter for an intra block copy (IBC) block is at least partially decided using information from a co-located block in a reference channel.

34. The method as claimed in claim 28, wherein the at least one filter comprises two or more filters derived for different sample intensity ranges in a template area, and applied to corresponding samples in those ranges in the current block.

35. The method as claimed in claim 28 further comprising determining at least one of a filter size or a filter type based on at least one of:
block size;
availability of reference samples in the neighborhood of the current block; or
availability of reference samples in the neighborhood of the reference block.

36. An apparatus comprising: at least one processor; and at least one memory storing instructions that, when executed by the at least one processor, cause the apparatus at least to perform:
copying a reference sample area of an image frame for a block copy-based image intra prediction where a block vector is either signaled by an encoder to a decoder or derived by both the encoder and the decoder through template matching;
deriving of at least one filter using at least a portion of reconstructed samples in template regions defined in neighborhood of a current block and/or neighborhood of a reference block;
applying the at least one of derived filters to at least partially modify the copied reference sample area to form a modified version of the copied reference sample area; and
using the modified version of the copied reference sample area for an image intra prediction to form another area of the same image frame.

37. The apparatus as claimed in claim 36, wherein to perform deriving parameters of the at least one filter and/or applying the at least one filter, the apparatus is caused to perform: using information available at a time of coding the current block comprising at least one of:
one or more of spatial reconstructed samples in a neighborhood of the current block;
one or more of spatial reconstructed samples in a neighborhood of the reference block;
one or more of spatial reconstructed samples in a neighborhood of a block other than the current block and other than the reference block;
one or more of location information of the spatial reconstructed samples in the neighborhood of the reference block;
one or more of location information of the spatial reconstructed samples in the neighborhood of the current block;
one or more of gradient information of the spatial reconstructed samples in the neighborhood of the current block;
one or more of gradient information of the spatial reconstructed samples in the neighborhood of the reference block;
one or more of direct coding (DC) or average values of the spatial reconstructed samples in the neighborhood of the current block;
one or more of direct coding (DC) or average values of the spatial reconstructed samples in the neighborhood of the reference block; or
a bias or an offset value.

38. The apparatus as claimed in claim 36, wherein the derivation of the at least one filter comprises determining filter coefficients based on minimization of an error.

39. The apparatus as claimed in claim 36, wherein to perform applying the at least one filter, the apparatus is caused to perform:
generating a list of reference candidates as reference blocks to be filtered;
deriving filter parameters for each candidate reference block;
applying the at least one filter on a template area of the reference block;
calculating a template cost using a metric based on difference of samples in a template of the current block and a template of reference blocks; and
selecting a block/filter pair based on the template cost.

40. The apparatus as claimed in claim 39, wherein the template cost is calculated using one or more of sum of absolute differences (SAD), sum of square errors (SSE), any other difference measuring metrics, or a distance measuring metric.

41. The apparatus as claimed in claim 36, wherein the apparatus is further caused to perform: determining to apply the at least one filter, wherein a decision for the applying the at least one filter for an intra block copy (IBC) block is at least partially decided using information from a co-located block in a reference channel.

42. The apparatus as claimed in claim 36, wherein the at least one filter comprises two or more filters derived for different sample intensity ranges in a template area, and applied to corresponding samples in those ranges in the current block.

43. The apparatus as claimed in claim 36, wherein the apparatus is further caused to perform: determining at least one of a filter size or a filter type based on at least one of:
block size;
availability of reference samples in the neighborhood of the current block; or
availability of reference samples in the neighborhood of the reference block.

44. A computer readable medium comprising program instructions that, when executed with an apparatus, cause the apparatus to perform at least the following:
copying a reference sample area of an image frame for a block copy-based image intra prediction where a block vector is either signaled by an encoder to a decoder or derived by both the encoder and the decoder through template matching;
deriving of at least one filter using at least a portion of reconstructed samples in template regions defined in neighborhood of a current block and/or neighborhood of a reference block;
applying the at least one of derived filters to at least partially modify the copied reference sample area to form a modified version of the copied reference sample area; and
using the modified version of the copied reference sample area for an image intra prediction to form another area of the same image frame.

45. The computer readable medium as claimed in claim 44, wherein to perform deriving parameters of the at least one filter and/or applying the at least one filter, the apparatus is caused to perform: using information available at a time of coding the current block comprising at least one of:
one or more of spatial reconstructed samples in a neighborhood of the current block;
one or more of spatial reconstructed samples in a neighborhood of the reference block;
one or more of spatial reconstructed samples in a neighborhood of a block other than the current block and other than the reference block;
one or more of location information of the spatial reconstructed samples in the neighborhood of the reference block;
one or more of location information of the spatial reconstructed samples in the neighborhood of the current block;
one or more of gradient information of the spatial reconstructed samples in the neighborhood of the current block;
one or more of gradient information of the spatial reconstructed samples in the neighborhood of the reference block;
one or more of direct coding (DC) or average values of the spatial reconstructed samples in the neighborhood of the current block;
one or more of direct coding (DC) or average values of the spatial reconstructed samples in the neighborhood of the reference block; or
a bias or an offset value.

46. The computer readable medium as claimed in claim 44, wherein the derivation of the at least one filter comprises determining filter coefficients based on minimization of an error.

47. The computer readable medium as claimed in claim 44, wherein to perform applying the at least one filter, the apparatus is caused to perform:
generating a list of reference candidates as reference blocks to be filtered;
deriving filter parameters for each candidate reference block;
applying the at least one filter on a template area of the reference block;
calculating a template cost using a metric based on difference of samples in a template of the current block and a template of reference blocks; and
selecting a block/filter pair based on the template cost.
